(19) United States
(12) Patent Application Publication
(10) Pub. No.: US 2023/0292195 A1
(43) Pub. Date: Sep. 14, 2023

(54) Conditional Handover Behavior Upon Dual Active Protocol Stacks Fallback

(71) Applicant: Telefonaktiebolaget LM Ericsson (publ), Stockholm (SE)

(72) Inventors: Jens Bergqvist, Linköping (SE); Icaro Leonardo Da Silva, Solna (SE)

(21) Appl. No.: 18/021,476

(22) PCT Filed: Aug. 18, 2021
(86) PCT No.: PCT/SE2021/050804

§ 371 Date: Feb. 15, 2023

Related U.S. Application Data
(60) Provisional application No. 63/067,024, filed on Aug. 18, 2020.

(51) Int. Cl. H04W 36/00; H04W 36/18

(52) U.S. Cl. CPC H04W 36/0079; H04W 36/185

(57) ABSTRACT

Methods in a user equipment, UE, for handling fallback from a failed handover, such as a dual-active protocol stack, DAPS, handover. An example method in a UE comprises receiving (710) a command instructing the UE to handover one or more radio bearers from a source cell to a target cell, where the command is received while the UE is evaluating execution conditions for a conditional reconfiguration; detecting (720) failure of the handover of at least one radio bearer from the source cell to the target cell; and, in response to said detecting, performing (730) evaluation of the execution conditions for the conditional reconfiguration.

### TECHNICAL FIELD

The present disclosure is related to connection reconfigurations, such as handovers, in wireless communication systems, and is more particularly related to techniques for handling connection reconfigurations during dual-active protocol stack (DAPS) handovers.

### BACKGROUND

Wireless Communication Systems in 3GPP

FIG. 1 illustrates a simplified wireless communication system, with a user equipment (UE) 102 that communicates with one or multiple access node 103, 104, which in turn are connected to a network node 106. The access nodes 103, 104 are part of the radio access network (RAN) 100.

For wireless communication systems confirming to the 3rd Generation Partnership Project (3GPP) specifications for the Evolved Packet System (EPS), also referred to as Long Term Evolution (LTE) or 4G, as specified in 3GPP TS 36.300 and related specifications, the access nodes 103, 104 correspond typically to base stations referred to in 3GPP specifications as Evolved NodeBs (eNBs), while the network node 106 corresponds typically to either a Mobility Management Entity (MME) and/or a Serving Gateway (SGW). The eNB is part of the RAN 100, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

On the other hand, for wireless communication systems pursuant to 3GPP specifications for the 3GPP 5G System, 5GS (also referred to as New Radio, NR, or 5G), as specified in 3GPP TS 38.300 and related specifications, the access nodes 103, 104 correspond typically to base stations referred to as 5G NodeBs, or gNBs, while the network node 106 corresponds typically to either a Access and Mobility Management Function (AMF) and/or a User Plane Function (UPF). The gNB is part of the RAN 100, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid a change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

5G is designed to support, among other things, new use cases requiring ultra-reliable low-latency communication (URLLC), such as factory automation and autonomous driving. To meet the stringent requirements on reliability and latency also during mobility, two new handover types are introduced in 5G Release 16. These two new handover types are called make-before-break handover and conditional handover. The make-before-break handover is also known as Dual Active Protocol Stacks (DAPS) handover. Both conditional handover and DAPS handover are relevant to this disclosure and are described in more detail below after a review of the NG-RAN architecture and the legacy handover procedure.

Similar to E-UTRAN in 4G, the NG-RAN (also referred to as the NR, or “new radio” network) uses a flat architecture and consists of base stations, called gNBs, which are interconnected with each other by means of the Xn-interface. A simplified illustration of the NG-RAN architecture is shown in FIG. 2. As seen in the figure, gNBs are also connected by means of the NG interface to the 5GC, more specifically to the AMF (Access and Mobility Management Function) by the NG-C interface and to the UPF (User Plane Function) by means of the NG-U interface. The gNB in turn supports one or more cells which provides the radio access to the UE. The radio access technology (called New Radio, NR) is OFDM based, like in LTE and offers high data transfer speeds and low latency. Note that “NR” is sometimes used to refer to the whole 5G system although strictly speaking it is only the 5G radio access technology.

It is expected that NR will be rolled out gradually on top of the legacy LTE network, starting in areas where high data traffic is expected. This means that NR coverage will be limited in the beginning and users must move between NR and LTE as they go in and out of coverage. To support fast mobility between NR and LTE and avoid change of core network, LTE eNBs will also connect to the 5GC and support the Xn interface. An eNB connected to 5GC is called a next generation eNB (ng-eNB) and is considered part of the NG-RAN (see FIG. 2).

Mobility in RRC CONNECTED State in LTE and NR

Mobility in RRC_CONNECTED state is also known as handover. The purpose of handover is to move the UE from a source access node using a source radio connection (also known as source cell connection), to a target access node, using a target radio connection (also known as target cell connection). The handover may be caused by movement of the UE, for example, or for other reasons where the target cell is better positioned to serve the UE. The source radio connection is associated with a source cell controlled by the source access node. The target radio connection is associated with a target cell controlled by the target access node. In other words, during a handover, the UE moves from the source cell to a target cell. Sometimes the source access node or the source cell is referred to as the “source”, and the target access node or the target cell is sometimes referred to as the “target”. The source access node and the target access node may also be referred to as the source node and the target node, the source radio network node and the target radio network node or the source gNB and the target gNB.

In some cases, the source access node and target access node are different nodes, such as different eNBs or gNBs. These cases are also referred to as inter-node handover, inter-eNB handover or inter-gNB handover. In other cases, the source access node and target access node are the same node, such as the same eNB and gNB. These cases are also referred to as intra-node handover, intra-eNB handover or intra-gNB handover and covers the case then source and target cells are controlled by the same access node. In yet other cases, handover is performed within the same cell (and thus also within the same access node controlling that cell)—these cases are also referred to as intra-cell handover.

It should therefore be understood that the terms “source access node” and “target access node” each refer to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An inter-node handover can further be classified as an Xn-based or NG-based handover depending on whether the source and target node communicate directly using the Xn interface or indirectly via the core network using the NG interface.

An RRC_CONNECTED UE in E-UTRAN or NG-RAN can be configured by the network to perform measurements of serving and neighbor cells and based on the measurement reports sent by the UE, the network may decide to perform a handover of the UE to a neighbor cell. The network then sends a Handover Command message to the UE (in LTE an RRConnectionReconfiguration message with a field called mobilityControlInfo and in NR an RRCReconfiguration message with a reconfigurationWithSync field).

These reconfigurations are actually prepared by the target access node upon a request from the source access node (over X2 or S1 interface in case of EUTRA-EPC or Xn or NG interface in case of NG-RAN-5GC) and take into account the existing Radio Resource Control (RRC) configuration and UE capabilities, as provided in the request from the source access node, as well as the capabilities and resource situation in the intended target cell and target access node. The reconfiguration parameters provided by the target access node contain, for example, information needed by the UE to access the target access node, e.g., random access configuration, a new C-RNTI assigned by the target access node and security parameters enabling the UE to calculate new security keys associated to the target access node so the UE can send a Handover Complete message (in LTE an RRConnectionReconfiguratioComplete message and in NR an RRCReconfigurationComplete message) on SRB1 encrypted and integrity protected based on new security keys upon accessing the target access node.

FIG. 3 shows the signaling flow between the UE and source and target access node during an Xn-based inter-node handover in NR. Similar steps take place during an LTE handover. This might be regarded as the “legacy” handover procedure, i.e., a handover procedure that does not utilize “make-before-break” techniques and does not incorporate the various techniques described herein. Details of the steps shown in FIG. 3 are provided below.
201-202. The UE and source gNB have an established connection and is exchanging user data. Due to some trigger, e.g. a measurement report from the UE, the source gNB decides to handover the UE to the target gNB.
203. The source gNB sends a handover request message, a “HO REQUEST, to the target gNB with necessary information to prepare the handover at the target side. The information includes among other things the current source configuration and the UE capabilities.
204. The target gNB prepares the handover and responds with a HO REQUEST ACKNOWLEDGE message to the source gNB, which includes the handover command (a RRCReconfiguration message containing the reconfigurationWithSync field) to be sent to the UE. The handover command includes information needed by the UE to access the target cell, e.g., random access configuration, a new C-RNTI assigned by the target access node and security parameters enabling the UE to calculate the target security key so the UE can send the handover complete message (a RRCReconfigurationComplete message).
   If the target gNB does not support the release of RRC protocol which the source gNB used to configure the UE, the target gNB may be unable to comprehend the UE configuration provided by the source eNB in the HO REQUEST. In this case, the target gNB can use so called “full configuration” to reconfigure the UE for handover. Full configuration option includes an initialization of the radio configuration, which makes the procedure independent of the configuration used in the source cell. Otherwise the target node uses so called “delta configuration” where only the delta to the radio configuration in the source cell is included in the handover command. Delta configuration typically reduces the size of the handover command which increases the speed and robustness of the handover.
205. The source gNB triggers the handovers by sending the handover command received from the target node in the previous step to the UE.
206. Upon reception of the handover command the UE releases the connection to the old cell before synchronizing and connecting to the new cell.
207-209. The source gNB stops scheduling any further DL or UL data to the UE and sends a SN STATUS TRANSFER message to the target gNB indicating the latest PDCP SN transmitter and receiver status. The source node now also starts to forward User Data to the target node, which buffers this data for now.
210. Once the UE the has completed the random access to the target cell, the UE sends the handover complete to the target gNB.
211. Upon receiving the handover complete message, the target node can start exchanging user data with the UE. The target node also requests the AMF to switch the DL data path from the UPF from the source node to the target node (not shown). Once the path switch is completed the target node sends the UE CONTEXT RELEASE message to the source node.

Handovers in NR like the one illustrated in FIG. 3 can be classified as break-before-make handovers, since the connection to the source cell is released before the connection to the target cell is established. These handovers therefore involve a short interruption of a few tens of milliseconds where no data can be exchanged between the UE and the network.

To achieve an interruption time of close to zero during handover, a new type of handover, known as Dual Active Protocol Stacks (DAPS) handover, is being introduced for NR and LTE in 3GPP Release 16. In DAPS handover the UE maintains the connection to the source cell while the connection to the target is being established. In other words, the UE maintains the source gNB connection after reception of an RRC message for handover (i.e., an RRCReconfiguration message with a reconfigurationWithSync element for the Master Cell Group, or MCG) and until it releases the source cell after a successful random access to the target gNB. Thus, the DAPS handover can be classified as make-before-break handover.

DAPS handover reduces the handover interruption but comes at the cost of increased UE complexity as the UE needs to be able to simultaneously receive/transmit from/to two cells at the same time. In practice this may require that the UE is equipped with dual transmit (TX)/receive (RX) chains. The dual TX/RX chains potentially also allow DAPS handover to be supported in other handover scenarios, such as inter-frequency handover.

An example of a DAPS inter-node handover procedure in LTE is illustrated in FIG. 4. Several steps of this procedure correspond directly to the same/similar steps in the legacy handover procedure illustrated in FIG. 3. Some of the steps of FIG. 4 are described below:
401-402. Same as steps 201-202 in the legacy handover in FIG. 3.
403-404. Similar to steps 203-204 in the legacy handover procedure except that the source node indicates that the handover is a DAPS handover.
405. The source eNB triggers the handovers by sending the handover command (a RRCReconfiguration message containing the reconfigurationWithSync field) received from the target node in the previous step to the UE. The handover command includes an indication to perform a DAPS handover.
406-411. Upon reception of the handover command with indication of a DAPS handover, the UE starts synchronizing to the target cell, e.g., starting with a random access request message as shown at step 407. Unlike in normal handover, the UE keeps the connection in the source cell and continues to exchange UL/DL data with the source eNB even after it has received the handover command. To decrypt/encrypt DL/UL data, the UE needs to maintain both the source and target security keys until the source cell is released. The UE can differentiate the security key to be used based on the cell which the DL/UL packet is received/transmitted on. If header compression is used the UE also needs to maintain two separate RObust Header Compression (ROHC) contexts for the source and target cell.
   The source node sends a SN STATUS TRANSFER message to the target node, as shown at step 406, and begins to forward DL data to the target eNB. Note that data that is forwarded may also be sent to the UE in the source cell, i.e., DL data may be duplicated. The target node buffers the DL data until the UE has connected with the target cell.
   Note that the Xn message for conveying the DL and (possibly) UL receiver status for early data transfer in the DAPS handover is not yet decided in 3GPP. One could either re-use the existing SN STATUS TRANSFER message (as indicated in the figure) or one could define a new message called e.g. EARLY FORWARDING TRANSFER.
   Once the UE the has completed the random access to the target cell, the UE sends the handover complete (a RRCReconfigurationComplete message) to the target eNB, as shown at step 408. After this point the UE receives DL data from both source and target cell while UL data transmission is switched to the target cell. The target eNB may then send a path switch request to the MME, as shown at step 409, which triggers path-related signaling between the MME and the SGW, as shown at step 410, to end the transmission of DL data via the source eNB. The MME acknowledges the path switch request, as shown at step 411.
412. AT this point, the source eNB stops scheduling any further DL or UL data to the UE. The target eNB sends a UE context release message to the source eNB, as shown at step 412.
413. The UE releases the source cell connection. From this point on, DL and UL data is only received and transmitted in the target cell.

Some highlights in this solution are:
In step 405, the UE receives a “DAPS Handover” indication in the Handover Command. This may be set on a per-bearer basis, and may be, for example, an RRCReconfiguration message with a reconfigurationWithSync element for the Master Cell Group (MCG). The UE maintains the connection to the source access node while establishing the connection to target cell associated with a target access node (for the bearers configured with DAPS). That is, the UE can send and receive DL/UL user plane data via the source access node between step 405-408 without any interruption for the respective bearers. After step 408, the UE has the target link available for UL/DL user plane data transmission, similar to the regular handover procedure. Furthermore, after step 408 and until the UE receives an indication from the target cell to release the source cell, the UE can also still receive DL user plane data from source cell, and perform some UL transmission to the source cell, such as control signaling related to the DL transfers in the source cell. The indication to release of the source cell is included by the target node in a RRCReconfiguration message, which is sent some time after the Random Access procedure is successfully completed and the DAPS handover thus is considered as successful (i.e., after step 407 or typically at some point after step 408). This RRCReconfiguration message is not shown in FIG. 4.
For DRBs configured with DAPS, downlink PDCP SDUs are forwarded with Sequence Number (SN) assigned by the source node (gNB), until SN assignment is handed over to the target gNB (which only happens later in the execution procedure).
In step 406, the source access node sends an SN status transfer message to the target access node, indicating UL PDCP receiver status and the SN of the first forwarded DL PDCP SDU. The uplink PDCP SN receiver status includes at least the PDCP SN of the first missing UL SDU and may include a bit map of the receive status of the out of sequence UL SDUs that the UE needs to retransmit in the target cell, if there are any such SDUs. The SN Status Transfer message also contains the Hyper Frame Number (HFN) of the first missing UL SDU as well as the HFN DL status for COUNT preservation in the target access node. In other words, for DRBs configured with DAPS, the source access node first sends the EARLY STATUS TRANSFER message. The DL COUNT value conveyed in the EARLY STATUS TRANSFER message indicates PDCP SN and HFN of the first PDCP SDU that the source node forwards to the target node. The source node does not stop assigning SNs to downlink PDCP SDUs until it sends the SN STATUS TRANSFER message to the target node in step 406.
Once the connection setup with the target access node is successful, i.e., after sending the Handover Complete message in step 408, the UE maintains two data links, one to the source access node and one to the target access node. This applies only to the downlink—after a successful random access to the target access node, the UE uses only the target access node for uplink data transmissions. Thus, after step 408, the UE transmits the UL user plane data on the target access node, similar to the regular handover procedure, using the target access node security keys and compression context. Thus, there is no need for simultaneous UL user data transmission to both nodes which avoids UE power splitting between two nodes and also simplifies UE implementation. In the case of intra-frequency handover, transmitting UL user plane data to one node at a time also reduces UL interference which increases the chance of successful decoding at the network side. Since there may be DL data transmissions ongoing in the source cell, the UE will, however, typically still need to perform some UL transmissions in the source cell, e.g. control signaling related to the DL transmissions.
The UE needs to maintain the security and compression context for both source access node and target access node until the source link is released. The UE can differentiate the security/compression context to be used for a PDCP PDU based on the cell which the PDU is transmitted on.
To avoid packet duplication, the UE may send a PDCP status report together with the Handover Complete message in step 408, indicating the last received PDCP SN. Based on the PDCP status report, the target access node can avoid sending duplicate PDCP packets (i.e., PDCP PDUs with identical sequence numbers) to the UE, i.e., PDCP packets which were already received by the UE in the source cell.
The release of the source cell in step 413 can, e.g., be triggered by an explicit message from the target access node (not shown in the figure) or by some other event such as the expiry of a release timer.

As an alternative to source access node starting packet data forwarding after step 405 (i.e., after sending the Handover Command to the UE, also known as “early packet forwarding”), the target access node may indicate to the source access node when to start packet data forwarding. For instance, the packet data forwarding may start at a later stage when the link to the target cell has been established, e.g., after the UE has performed random access in the target cell or when the UE has sent the RRC

Connection Reconfiguration Complete message to the target access node (also known as “late packet forwarding”). By starting the packet data forwarding in the source access node at a later stage, the number of duplicated PDCP SDUs received by the UE from the target cell will potentially be less and by that the DL latency will be somewhat reduced. However, starting the packet data forwarding at a later stage is also a trade-off between robustness and reduced latency if, e.g., the connection between the UE and the source access node is lost before the connection to the target access node is established. In such case there will be a short interruption in the DL data transfer to the UE.

It will be appreciated that the NR procedure for DAPS handover is similar to the LTE procedure shown in FIG. 4.

As noted above, DAPS can be performed on a per-bearer basis. DAPS configuration for a given bearer is provided as part of the RadioBearerConfig, for each dedicated radio bearer (DRB) to be configured with DAPS, as shown below, wherein the RadioBearerConfig information element (IE) is included in the RRCReconfiguration with a reconfigurationWithSync for the MCG:
------------------begin RadioBearerConfig definition-------------------------

| | | |
|---|---|---|
| RadioBearerConfig ::= | | SEQUENCE { |
| drb-ToAddModList | | DRB-ToAddModList |
| OPTIONAL, | -- Cond HO-toNR | |
| ... | | |
| } | | |
| . . . | | |
| DRB-ToAddModList ::= | | SEQUENCE (SIZE (1..maxDRB)) OF |
| DRB-ToAddMod | | |
| DRB-ToAddMod ::= | | SEQUENCE { |
| cnAssociation | | CHOICE { |
| eps-BearerIdentity | | INTEGER (0..15), |
| sdap-Config | | SDAP-Config |
| } | | |
| OPTIONAL, | -- Cond DRBSetup | |
| drb-Identity | | DRB-Identity, |
| reestablishPDCP | | ENUMERATED{true} |
| OPTIONAL, | -- Need N | |
| recoverPDCP | | ENUMERATED{true} |
| OPTIONAL, | -- Need N | |
| pdcp-Config | | PDCP-Config |
| OPTIONAL, | -- Cond PDCP | |
| ..., | | |
| [[ | | |
| daps-Config-r16 | | ENUMERATED{true} |
| OPTIONAL | -- Need N | |
| ]] | | |
| } | | |
| ... | | |

------------------end RadioBearerConfig definition-------------------------

For the purposes of the present disclosure, the term DAPS handover should be understood as a handover procedure in which the UE maintains a distinct uplink/downlink connection to the source base station after reception of an RRC message for handover and until releasing the source cell after successful random access to the target base station. Thus, unlike Rel-14 make before break, with a DAPS handover, the UE does not release the connection to the source base station until after its first transmission (e.g., the PRACH preamble) to the target base station.

It will be appreciated that a DAPS handover in accordance with the above definition may carry a different name, in various contexts. It will be further appreciated, however, that a DAPS handover is distinct from such things as soft handover, MIMO, multi-transmission point transmission/reception, dual connectivity, etc. Each of these also involve redundant paths from the UE to the network, where an endpoint combines information from the paths into a reliable stream of data. However, the combining is done on different protocol layers, and most of these do not involve a handover in that a source cell is released once a connection to the target cell is established. In soft handover, the same bitstream is transmitted to the UE from two different cells, where combining is done at the physical layer. With soft handover, there are not distinct UL/DL links between the UE and two base stations, but merely a redundant bitstream. The other examples mentioned above involve redundant paths or transmission layers, but these redundant paths or transmission layers are distinct from a handover scenario.

In case of DAPS handover, the UE continues the downlink user data reception from the source eNB or gNB until releasing the source cell, i.e., daps-SourceRelease message transmitted by the target, and continues the uplink user data transmission to the source eNB or gNB until successful random access procedure to the target eNB or gNB. To do that, the UE should keep performing radio link monitoring (RLM) with respect to the source cell for the whole duration of the handover, i.e., until an RRCReconfigurationComplete message containing handover completion information is transmitted. That implies, for example, that the UE should keep monitoring possible out-of-sync indications, whether the RLC retransmissions with the source exceed the threshold, etc. Obviously, in case RLF occurs in the source cell while performing DAPS, the UE releases the source connection, but it can continue the DAPS handover to the target.

The UE configured with DAPS handover can continue with UL transmissions towards the source cell until the handover is completed in the target, i.e., RRCReconfigurationComplete is transmitted to the target.

For the DL, the source network node (e.g., a source gNB) can keep sending DL data until the source configuration release, conveyed in the daps-SourceRelease message transmitted by the target (after having received the RRCReconfigurationComplete), is received by the UE. Hence, even though UL data transmission to the source cell will not be prolonged beyond the handover completion, some UL transmissions to the source cell should be performed towards the source cell after the handover completion, such as HARQ ACK/NACK and other possible layer-1 control signaling.

A handover procedure triggered by RRC generally requires the UE at least to reset the Medium Access Control (MAC) entity and re-establish Radio Link Control (RLC). For DAPS handover, however, upon reception of the handover command, the UE:
Creates a MAC entity for target (i.e. a different/new MAC entity);
Establishes the RLC entity and an associated DTCH logical channel for target for each DRB configured with DAPS;
For the DRB configured with DAPS, reconfigures the PDCP entity with separate security and ROHC functions for source and target and associates them with the RLC entities configured by source and target respectively;
Retains the rest of the source configurations until release of the source.

For DRBs configured with DAPS, the source gNB does not stop transmitting downlink packets until it receives the HO SUCCESS message from the target gNB. In RRC, UE actions are defined as follows:
---------------------begin RRC specification excerpts------------------------------
5.3.5.5.2 Reconfiguration with sync
The UE shall perform the following actions to execute a reconfiguration with sync.
   . . .
   1> if no DAPS bearer is configured:
      2> stop timer T310 for the corresponding SpCell, if running;
   . . .
   1> If any DAPS bearer is configured:
      2> create a MAC entity for the target cell group with the same configuration as the MAC entity for the source cell group;
      2> for each DAPS bearer:
         3> establish an RLC entity or entities for the target cell group, with the same configurations as for the source cell group;
         3> establish the logical channel for the target cell group, with the same configurations as for the source cell group;
         . . .
      2> apply the value of the newUE-Identity as the C-RNTI in the target cell group;
      2> configure lower layers for the target SpCell in accordance with the received spCellConfigCommon;
      2> configure lower layers for the target SpCell in accordance with any additional fields, not covered in the previous, if included in the received reconfigurationWithSync.
      . . .
5.3.5.5.4 RLC bearer addition/modification
For each RLC-BearerConfig received in the rlc-BearerToAddModList IE the UE shall:
   1> if the UE's current configuration contains an RLC bearer with the received logicalChannelIdentity within the same cell group:
      2> if the RLC bearer is associated with an DAPS bearer:
         3> reconfigure the RLC entity or entities for the target cell group in accordance with the received rlc-Config;
         3> reconfigure the logical channel for the target cell group in accordance with the received mac-LogicalChannelConfig;
      2> else:
      . . .
5.3.5.5.5 MAC entity configuration
The UE shall:
   1> if SCG MAC is not part of the current UE configuration (i.e. SCG establishment):
      2> create an SCG MAC entity;
   1> if any DAPS bearer is configured:
      2> reconfigure the MAC main configuration for the target cell group in accordance with the received mac-CellGroupConfig excluding tag-ToReleaseList and tag-ToAddModList;
         . . .
---------------------end RRC specification excerpts------------------------------

FIG. 5 shows an example of the protocol stack at the UE side at Dual Active Protocol Stack (DAPS) handover. Each user plane radio bearer has an associated PDCP entity which in turn has two associated RLC entities—one for the source cell and one for the target cell. The PDCP entity uses different security keys and ROHC contexts for the source and target cell while the SN allocation (for UL transmission) and re-ordering/duplication detection (for DL reception) is common. This may be contrasted with dual connectivity (DC), for example, where a common PDCP entity is used, on top of separate RLC/MAC/PHY stacks for each of the two dual-connectivity carriers.

Note that in case of NR, there is an additional protocol layer called Service Data Adaptation Protocol (SDAP), on top of PDCP. SDAP is responsible for mapping QoS flows to bearers. This layer is not shown in FIG. 5 and will not be discussed further in this document.

DAPS Fallback

DAPS Fallback is a procedure where the UE fails to perform a DAPS handover (expiry of timer T304) and then, in case RLF has not been detected in the source cell, comes back to the source cell (reverting back configurations according to the source) and sending a Failure Information message to the source.
---------------------begin RRC specification excerpts------------------------------
5.3.5.8.3 T304 expiry (Reconfiguration with sync Failure)
The UE shall:
   1> if T304 of the MCG expires:
      2> release dedicated preambles provided in rach-ConfigDedicated if configured;
      2> release dedicated msgA PUSCH resources provided in rach-ConfigDedicated if configured;
      2> if any DAPS bearer is configured, and radio link failure is not detected in the source PCell, according to subclause 5.3.10.3:
         3> release target PCell configuration;
         3> reset MAC for the target PCell and release the MAC configuration for the target PCell;
         3> for each DAPS bearer:
         4> release the RLC entity or entities as specified in TS 38.322 [4], clause 5.1.3, and the associated logical channel for the target PCell;
         4> reconfigure the PDCP entity to release DAPS as specified in TS 38.323 [5];
         3> for each SRB:
         4> if the masterKeyUpdate was not received:
         5> configure the PDCP entity for the source PCell with state variables continuation as specified in TS 38.323 [5], the state variables as the PDCP entity for the target PCell;
         4> release the PDCP entity for the target PCell;
         4> release the RLC entity as specified in TS 38.322 [4], clause 5.1.3, and the associated logical channel for the target PCell;
         4> trigger the PDCP entity to perform SDU discard as specified in TS 38.323 [5];
         4> re-establish the RLC entity for the source PCell;
         3> release the physical channel configuration for the target PCell;
         3> revert back to the SDAP configuration used in the source PCell;
         3> discard the keys used in target PCell (the K_{gNB} key, the K_{RRCenc} key, the K_{RRCint} key, the K_{UPint} key and the K_{UPenc} key), if any;
         3> resume suspended SRBs in the source PCell;
         3> for each non DAPS bearer:
         4> revert back to the UE configuration used for the DRB in the source PCell, includes PDCP, RLC states variables, the security configuration and the data stored in transmission and reception buffers in PDCP and RLC entities;
         3> revert back to the UE measurement configuration used in the source PCell;
         3> initiate the failure information procedure as specified in subclause 5.7.5 to report DAPS handover failure.
   . . .
5.7.5 Failure information
5.7.5.1 General
The purpose of this procedure is to inform the network about a failure detected by the UE.
5.7.5.2 Initiation
A UE initiates the procedure when there is a need inform the network about a failure detected by the UE. In particular, the UE initiates the procedure when the following condition is met:
   1> upon detecting failure for an RLC bearer, in accordance with 5.3.10.3;
   1> upon detecting DAPS handover failure, in accordance with 5.3.5.8.3;
Upon initiating the procedure, the UE shall:
   1> initiate transmission of the FailureInformation message as specified in 5.7.5.3;
5.7.5.3 Actions related to transmission of FailureInformation message
The UE shall:
   . . .
   1> if initiated to provide DAPS failure information, set FailureInfoDAPS as follows:
      2> set the failureType as daps failure;
   1> if used to inform the network about a failure for an MCG RLC bearer or DAPS failure information:
      2> submit the FailureInformation message to lower layers for transmission via SRB1;
      . . .
---------------------end RRC specification excerpts------------------------------

Conditional Handover

Conditional handover (CHO) is described in 3GPP specifications in stage 2, 3GPP TS 38.300 in chapter 9.2.3.4. A CHO is defined as a handover that is executed by the UE when one or more handover execution conditions are met. The UE starts evaluating the execution condition(s) upon receiving the CHO configuration, and stops evaluating the execution condition(s) once the execution condition(s) is met.

The following principles apply to CHO:
The CHO configuration contains the configuration of CHO candidate cell(s) generated by the candidate access node (e.g., source eNB or gNB) and execution condition(s) generated by the source access node.
An execution condition may consist of one or two trigger condition(s) (CHO events A3/A5, as defined in 3GPP specifications). Only a single reference signal (RS) type is supported and at most two different trigger quantities, e.g., Received Signal Reference Power (RSRP) and Received Signal Reference Quality (RSRQ), RSRP and signal-to-interference-plus-noise ratio (SINR), etc., can be configured simultaneously for the evolution of CHO execution condition of a single candidate cell.
Before any CHO execution condition is satisfied, upon reception of handover command (without CHO configuration), the UE executes the handover procedure, regardless of any previously received CHO configuration.
While executing CHO, i.e. from the time when the UE starts synchronization with target cell, UE does not monitor source cell.

As in intra-NR RAN handover, in intra-NR RAN CHO the preparation and execution phase of the conditional handover procedure is performed without involvement of the 5GC; i.e., preparation messages are directly exchanged between gNBs. The release of the resources at the source gNB during the conditional handover completion phase is triggered by the target gNB. FIG. 6 depicts the basic conditional handover scenario where neither the Access Mobility Function (AMF) nor the User Plane Function (UPF) changes.

The steps shown in FIG. 6 are described below:
0/1. Same as step 0, 1 in FIG. 9.2.3.2.1-1 of section 9.2.3.2.1 in 3GPP TS 38.300.
2. The source gNB decides to use CHO.
3. The source gNB issues a Handover Request message to one or more candidate gNBs.
4. Same as step 4 in FIG. 9.2.3.2.1-1 of section 9.2.3.2.1.
5. The candidate gNB sends HANDOVER REQUEST ACKNOWLEDGE message including configuration of CHO candidate cell to the source gNB.
6. The source gNB sends an RRCReconfiguration message to the UE, containing the configuration of CHO candidate cell(s) and CHO execution condition(s).
7. UE sends an RRCReconfigurationComplete message to the source gNB.
8. UE maintains connection with source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronizes to that candidate cell and completes the RRC handover procedure by sending RRCReconfigurationComplete message to the target gNB. The UE releases stored CHO configurations after successful completion of RRC handover procedure.

Two specific aspects to highlight about CHO that are directly related to the problem the invention addresses are the following:
Before any CHO execution condition is satisfied, upon reception of handover command (without CHO configuration), the UE executes the handover procedure as described in clause 9.2.3.2 of 3GPP TS 38.300, regardless of any previously received CHO configuration.
The UE stops evaluating the execution condition(s) once the execution condition(s) is met (these are started when CHO configurations are received).

### SUMMARY

When a UE is performing the evaluation of conditional handover (CHO) conditions, it may receive a handover command, which may trigger a DAPS handover. If this DAPS handover fails, e.g., upon expiry of timer T304, but no radio link failure has been determined for the source cell, the UE will generally fall back to the source cell, and transmit a Failure Information message to the source cell. However, it is unclear what the UE behavior should be with respect to conditional reconfigurations that were under evaluation prior to receipt of the handover command. The techniques presented herein address this problem.

Example embodiments according to some of the techniques described herein comprise a method carried out by a UE. This example method comprises receiving a command instructing the UE to handover one or more radio bearers from a source cell to a target cell, where the command is received while the UE is evaluating execution conditions for a conditional reconfiguration. The example method further comprises detecting failure of the handover of at least one radio bearer from the source cell to the target cell and, in response to said detecting, performing evaluation of the execution conditions for the conditional reconfiguration. This may comprise, for example, stopping evaluation of the execution conditions for the one or more conditional reconfigurations in response to receiving the command and then re-starting evaluation of the execution conditions for the conditional reconfiguration in response to detecting the failure of the handover, in some embodiments. In other embodiments, the UE continues evaluation of the execution conditions for the conditional reconfiguration after receiving the command—in other words, the UE does not stop or suspend the evaluation of the execution conditions in response to receiving the handover command.

Other example embodiments include another method carried out be a UE, in this case where a handover, such as a DAPS handover, is successful. This example method includes the step of receiving a command instructing the UE to handover one or more radio bearers from a source cell to a target cell, where the command is received while the UE is evaluating execution conditions for a conditional reconfiguration. This method further comprises continuing evaluation of the execution conditions for the one or more conditional reconfigurations after receiving the command, in response to determining that the received command configures a dual-active protocol stack, DAPS, handover of at least one of the one or more radio bearers. This method still further comprises subsequently discontinuing evaluation of the execution conditions for the one or more conditional reconfigurations, in response to a successful handover. This discontinuing of the evaluation may be more specifically in response to for example, any of: completing a random access procedure in the target cell, releasing the source cell upon completion of the handover, and stopping of a timer in response to successful handover.

Another example method for handling a fallback after failure of a handover, such as a DAPS handover, as carried out by a user equipment also comprises the step of receiving a command instructing the UE to handover one or more radio bearers from a source cell to a target cell, where the command is received while the UE is evaluating execution conditions for a conditional reconfiguration. This method further includes the steps of stopping evaluation of the execution conditions for the conditional reconfiguration, in response to receiving the command, and detecting failure of the handover of at least one radio bearer from the source cell to the target cell. In this method, however, instead of continuing or re-starting evaluation of the execution conditions in response to detecting the failure, the UE instead sends, to the source cell, an indication that evaluation of the execution conditions for the conditional reconfiguration has stopped. In some embodiments or instances, the network may decide that the evaluation of the execution conditions for the conditional configuration should be re-started. Thus, in some embodiments, the method further comprises the steps of receiving, from the source cell, subsequent to sending the indication that evaluation of the execution conditions for the conditional reconfiguration has stopped, an indication to resume evaluation of the execution conditions for the conditional reconfiguration, and resuming evaluation of the execution conditions for the conditional reconfiguration, in response to receiving the indication from the source cell.

Other embodiments of the techniques described herein include a method carried out in a network node, with this example method complementing the method summarized immediately above. This method includes the step of sending a command instructing the UE to handover one or more radio bearers from a source cell to a target cell. This may be a command instructing a DAPS handover, for example. This method further comprises receiving, from the UE, an indication that evaluation by the U E of execution conditions for a conditional reconfiguration configured for the UE has stopped. Receipt of this indication allows the network node to consider whether evaluation of the execution conditions for the conditional configuration should be re-started. Thus, in some embodiments and/or instances, this method may further comprise sending, to the UE, subsequent to receiving the indication that evaluation of the execution conditions for the conditional reconfiguration has stopped, an indication to resume evaluation of the execution conditions for the conditional reconfiguration.

Other embodiments described herein include apparatuses and systems configured out to carry one or several of the methods described herein, as well as numerous variations thereof.

### BRIEF DESCRIPTION OF THE FIGURES

FIG. 1 is a simplified illustration of a wireless communication system.

FIG. 2 illustrates the NG-RAN architecture.

FIG. 3 illustrates handover in NR.

FIG. 4 is a signaling diagram illustrating a dual-active protocol stack (DAPS) handover in LTE.

FIG. 5 is a block diagram illustrating a dual active protocol stack (DAPS) on a UE.

FIG. 6 is a signaling flow illustrating an intra-AMF/UPF conditional handover (CHO).

FIG. 7 is a process flow diagram illustrating an example method in a UE.

FIG. 8 is a flow diagram illustrating another example method in a UE.

FIG. 9 is a flow diagram illustrating another example method in a UE.

FIG. 10 is a flow diagram illustrating an example method in a network node.

FIG. 11 is a block diagram illustrating an example UE.

FIG. 12 is a block diagram illustrating an example network node.

FIG. 13 is a block diagram of an exemplary wireless network configurable according to various exemplary embodiments of the present disclosure.

FIG. 14 is a block diagram of an exemplary user equipment (UE) configurable according to various exemplary embodiments of the present disclosure.

FIG. 15 is a block diagram of illustrating a virtualization environment that can facilitate virtualization of various functions implemented according to various exemplary embodiments of the present disclosure.

FIGS. 16-17 are block diagrams of exemplary communication systems configurable according to various exemplary embodiments of the present disclosure.

FIGS. 18-21 are flow diagrams illustrating various exemplary methods and/or procedures implemented in a communication system, according to various exemplary embodiments of the present disclosure.

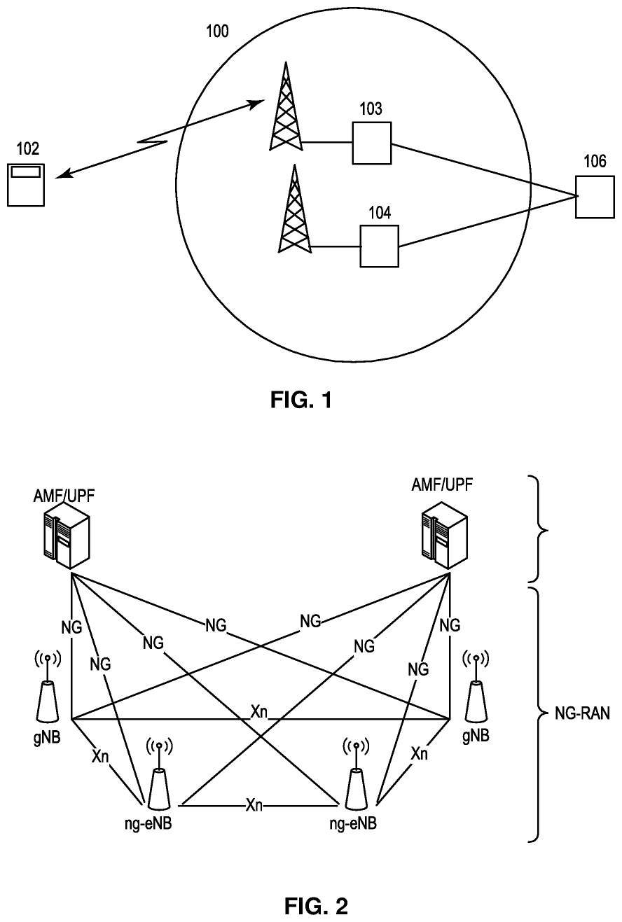

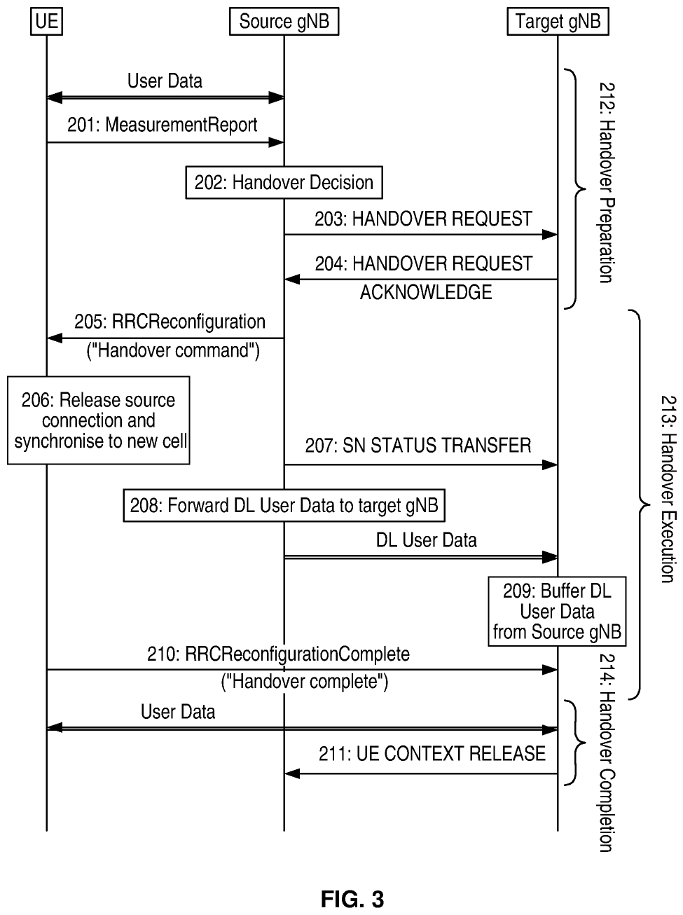

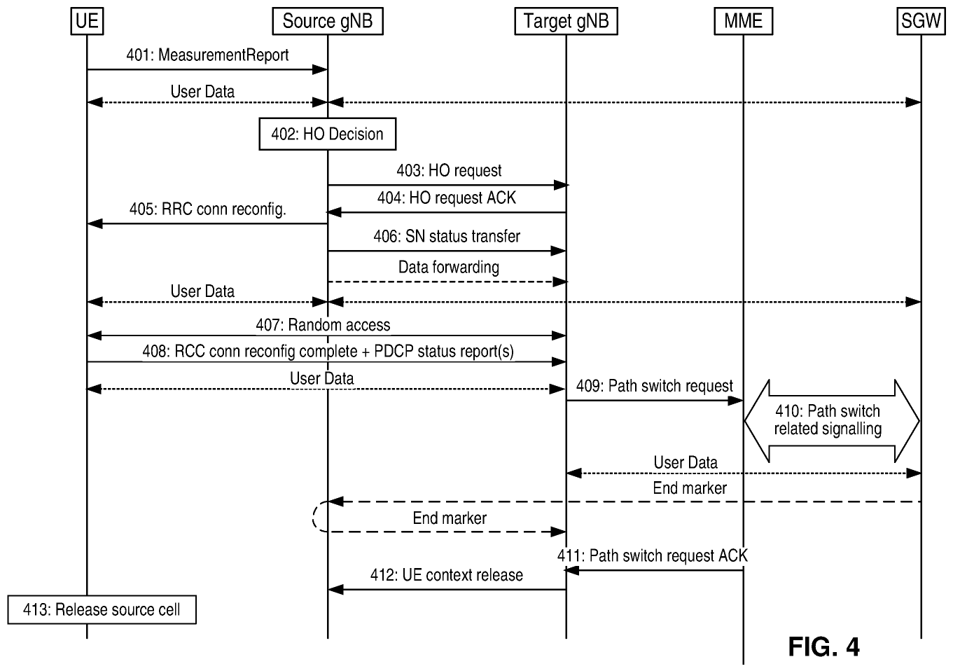

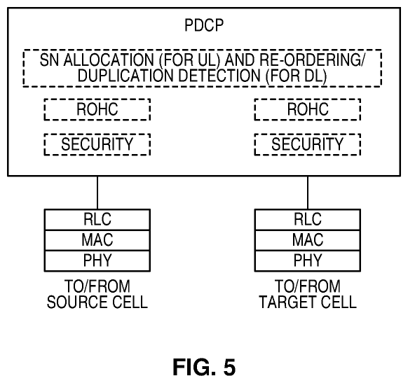

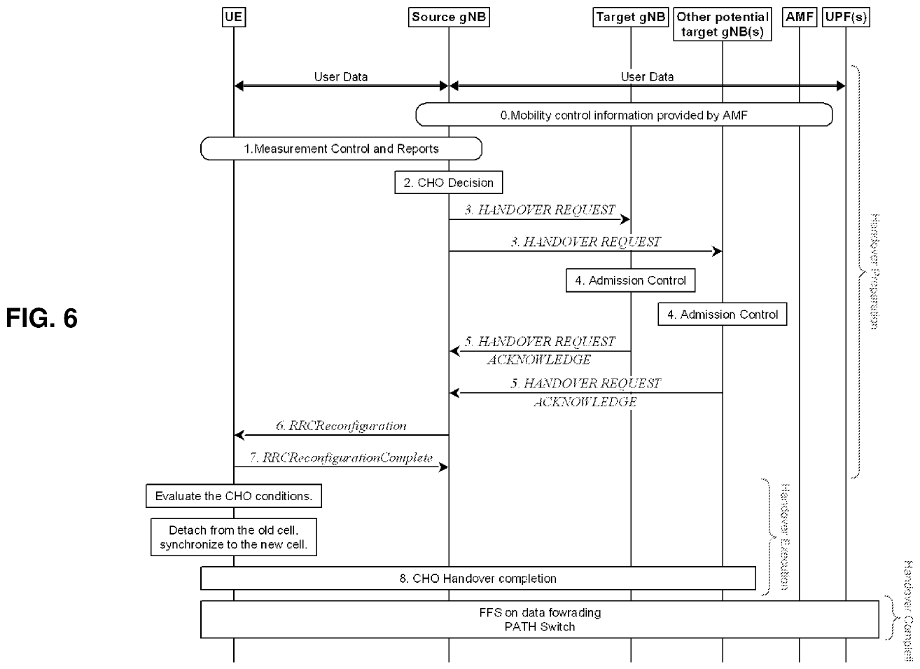

### DETAILED DESCRIPTION

When a UE is configured with CHO and execution conditions for a given target candidate cell are fulfilled, the UE stops evaluating the CHO trigger/execution conditions. The reasons for stopping evaluating the conditions are at least two-fold:
First, continuing would be unnecessary, since the UE is already executing CHO with a target candidate and if that fails (T304 expires), a procedure clearly specifies the UE behavior: either UE performs re-establishment or the UE can apply one of the other stored CHO (regardless if conditions would be fulfilled or not).
Second, stopping the monitoring avoids any ambiguity in the sense of what the UE should do if this occurs in the middle of another execution, for example, execution conditions for target candidate cell-A are fulfilled while timer T304 is running (i.e, while UE tries to access cell-B).

While the UE is performing the evaluation of CHO execution conditions, the UE may receive a HO command (i.e., an RRCReconfiguration including a reconfiguration with sync), either for one of the target candidates configured for CHO, or any other cell. In this case the UE then also should stop evaluating trigger/execution conditions for the conditional reconfiguration(s), if any. The received HO command may include a DAPS configuration for at least one bearer, thus triggering a DAPS HO, and upon applying the message the UE then starts to execute the DAPS HO and stops evaluations of conditional reconfiguration(s) (e.g. CHO).

If the UE detects a failure (e.g., expiry of timer T304) for a DAPS HO, i.e. a handover configured with at least one DAPS bearer, and no radio link failure has been determined for the source cell, the UE will perform a fallback to the source cell, which includes reverting back to the previous configuration (as described in 3GPP TS 38.331, see 5.3.5.8.3). The UE will then transmit a Failure Information message to the source cell, indicating that there is a DAPS fallback (i.e., a failure of a DAPS handover). However, if the UE was configured with one or more conditional reconfiguration(s), e.g. CHO or CPC, it is then unclear what the UE behavior should be concerning these configurations when the UE has returned to the source cell as part of the DAPS fallback procedure. In the event that the UE does not restart the evaluation of the conditional reconfiguration(s) after the fallback to the source cell, for example, there is then a risk that no HO execution is started, for instance, even though the UE has entered an area where it would be needed.

The techniques described herein address this problem, and include a method performed at a wireless terminal capable of being configured with CHO, and capable of being configured with DAPS handover, where the method comprises:
Receiving a HO command including a DAPS configuration for at least one bearer, wherein the UE receives the HO command while the UE is performing the evaluation of execution conditions for conditional reconfiguration(s), e.g. CHO;
Stopping the evaluation of conditional reconfiguration (e.g. stop the actions defined in 3GPP TS 38.331, 5.3.5.13.4);
Detecting a HO failure for the DAPS HO (e.g., a detection that timer T304 has expired);
If radio link failure has not been detected in the source PCell for the DAPS HO (i.e., a DAPS fallback is triggered), re-start the evaluation of conditional reconfiguration(s) (according to CHO configuration provided by source) as a part of, or in relation to, the DAPS fallback procedure.

In legacy, only the reception of a CHO configuration triggers the UE to initiate the evaluation of conditional reconfiguration conditions. However, according to the method, a new condition is added: the detection of a DAPS fallback when UE has configured CHO configurations that are stopped

One of the advantages of this method is that the UE behavior is predictable in a DAPS fallback procedure concerning the handling of conditional reconfiguration(s), e.g., the CHO behavior. In other words, if the scenario happens in current specifications without the method being applied, the UE could possibly remain with CHO conditions stopped even though it has come back to the source cell after a DAPS HO fallback.

Even if the network would know, e.g., for some UE vendors, that this is the predictable behavior, to re-activate CHO the source network node would need to re-configure CHO so that upon reception the UE starts to perform evaluate the conditional reconfiguration conditions, as these are only started in legacy upon reception of the CHO configuration.

Initial Considerations

The techniques described herein are applicable to several procedures in 3GPP networks (or similar wireless networks), including Conditional Handover (CHO), Conditional PSCell Change (CPC), and/or Conditional PSCell Addition (CPA), and/or Conditional PSCell Change/Addition (CPAC) configuration and procedures (like CHO execution). The terms “conditional reconfiguration” or “conditional configuration” should be understood as referring to any of these. In 3GPP networks, the message that is stored and applied upon fulfillment of a condition is an RRCReconfiguration or RRCConnectionReconfiguration). Terminology wise, one could also interpret conditional handover (CHO) in a broader sense, also covering CPC (Conditional PSCell Change) or CPAC (Conditional PSCell Addition/Change) procedures.

This document describes a Handover command including a DAPS configuration for at least one bearer. That can correspond to an RRC Reconfiguration like message (e.g., an NR RRC message RRCReconfiguration or an LTE RRC message RRCConnectionReconfiguration) including a DAPS configuration (e.g., inclusion of a daps-Config field) in at least one bearer configuration (e.g., within DRB-ToAddMod). The configuration of a DAPS handover may, however, also be done without any DAPS indication within a bearer configuration, e.g. by having a DAPS configuration within reconfigurationWithSync or mobilityControlInfo.

This document also describes the evaluation of CHO conditions. This may correspond to the actions as defined in 3GPP TS 38.331, “5.3.5.13.4 Conditional reconfiguration evaluation”, as follows:
-----------------------begin 3GPP excerpts-------------------------------------------
   5.3.5.13.4 Conditional reconfiguration evaluation
   The UE shall:
      1> for each condReconfigId within the VarConditionalReconfig:
         2> consider the cell which has a physical cell identity matching the value indicated in the ServingCellConfigCommon included in the reconfigurationWithSync in the received condRRCReconfig to be applicable cell;
         2> for each measId included in the measIdList within VarMeasConfig indicated in the condExecutionCond associated to condReconfigId:
         3> if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
         4> consider the event associated to that measId to be fulfilled;
         3> if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
         4> consider the event associated to that measId to be not fulfilled;
         2> if event(s) associated to all measId(s) within condTriggerConfig for a target candidate cell within the stored condRRCReconfig are fulfilled:
         3> consider the target candidate cell within the stored condRRCReconfig, associated to that condReconfigId, as a triggered cell;
         3> initiate the conditional rconfiguration execution, as specified in 5.3.5.13.5;
      NOTE: Up to 2 MeasId can be configured for each condReconfigId. The conditional handover event of the 2 MeasId may have the same or different event conditions, triggering quantity, time to trigger, and triggering threshold.
-----------------------end 3GPP excerpts-------------------------------------------

Hence, stopping or re-starting the evaluation of CHO conditions can correspond to at least stopping or re-starting the actions as described above.

UE Embodiments—Stop Upon HO and Re-Start/Resume Upon DAPS Fallback

In some embodiments of the presently disclosed techniques, the UE receives a HO command including a DAPS configuration for at least one bearer, where the UE receives the HO command while the UE is performing the evaluation of execution conditions for conditional reconfiguration(s), e.g. CHO. In response, the UE stops the evaluation of conditional reconfiguration (e.g., stopping the actions defined in 3GPP TS 38.331, § 5.3.5.13.4). Then, upon detecting a HO failure in the DAPS HO (e.g., by detecting that timer T304 expires for the HO that is configured with DAPS for at least one bearer) and if radio link failure is not detected in the source PCell, the UE re-starts the evaluation of conditional reconfiguration(s), e.g., according to a CHO configuration previously provided by the source.

In legacy devices operating according to 3GPP specifications, only the reception of a conditional configuration, e.g., CHO configuration, triggers the UE to initiate the evaluation of conditional reconfiguration conditions. According to the method described here, a new trigger for starting CHO evaluation is added: the detection of a DAPS HO fallback, i.e., fallback to the source cell at a DAPS HO failure (e.g., due to expiry of timer T304) when the UE has conditional configuration(s) that have been stopped as a consequence of receiving the DAPS HO command.

Specific procedures according to this technique can be possibly specified in the RRC specification (e.g., 3GPP TS 38.331) as follows, where the restart of the evaluation of conditional reconfiguration is included in sub-clause 5.3.5.8.3:
--------------begin proposed specification------------------------
   5.3.5.5.2 Reconfiguration with sync
   The UE shall perform the following actions to execute a reconfiguration with sync.
      1> if the AS security is not activated, perform the actions upon going to RRC_IDLE as specified in 5.3.11 with the release cause ‘other’ upon which the procedure ends;
      1> if no DAPS bearer is configured:
         2> stop timer T310 for the corresponding SpCell, if running;
      1> if this procedure is executed for the MCG:
         2> if timer T316 is running;
         3> stop timer T316;
         3> clear the information included in VarRLF-Report, if any;
         2> resume MCG transmission, if suspended.
      1> stop timer T312 for the corresponding SpCell, if running;
      1> start timer T304 for the corresponding SpCell with the timer value set to t304, as included in the reconfigurationWithSync;
      1> stop the evaluation of conditional reconfiguration (as defined in 5.3.5.13.4);
         . . .
      1> start synchronising to the DL of the target SpCell;
. . .
   5.3.5.8.3 T304 expiry (Reconfiguration with sync Failure)
   The UE shall:
      1> if T304 of the MCG expires:
         2> release dedicated preambles provided in rach-ConfigDedicated if configured;
         2> release dedicated msgA PUSCH resources provided in rach-ConfigDedicated if configured;
         2> if any DAPS bearer is configured, and radio link failure is not detected in the source PCell, according to subclause 5.3.10.3:
         3> release target PCell configuration;
         3> reset MAC for the target PCell and release the MAC configuration for the target PCell;
         3> for each DAPS bearer:
         4> release the RLC entity or entities as specified in TS 38.322 [4], clause 5.1.3, and the associated logical channel for the target PCell;
         4> reconfigure the PDCP entity to release DAPS as specified in TS 38.323 [5];
         3> for each SRB:
         4> if the masterKeyUpdate was not received:
         5> configure the PDCP entity for the source PCell with state variables continuation as specified in TS 38.323 [5], the state variables as the PDCP entity for the target PCell;
         4> release the PDCP entity for the target PCell;
         4> release the RLC entity as specified in TS 38.322 [4], clause 5.1.3, and the associated logical channel for the target PCell;
         4> trigger the PDCP entity to perform SDU discard as specified in TS 38.323 [5];
         4> re-establish the RLC entity for the source PCell;
         3> release the physical channel configuration for the target PCell;
         3> revert back to the SDAP configuration used in the source PCell;
         3> discard the keys used in target PCell (the K_{gNB} key, the K_{RRCenc} key, the K_{RRCint} key, the K_{UPint} key and the K_{UPenc} key), if any;
         3> resume suspended SRBs in the source PCell;
         3> for each non DAPS bearer:
         4> revert back to the UE configuration used for the DRB in the source PCell, includes PDCP, RLC states variables, the security configuration and the data stored in transmission and reception buffers in PDCP and RLC entities;
         3> revert back to the UE measurement configuration used in the source PCell;
         3> re-start the evaluation of conditional reconfiguration (as defined in 5.3.5.13.4);
         3> initiate the failure information procedure as specified in subclause 5.7.5 to report DAPS handover failure.
   . . .
--------------end proposed specification------------------------

UE Embodiments—Stop ONLY if not a DAPS HO, No Need to Re-Start/Resume Upon DAPS Fallback

In another approach according to the presently disclosed techniques, the UE receives a HO command configuring a DAPS HO (e.g., by inclusion of a DAPS configuration for at least one bearer), where the UE receives the HO command while the UE is performing the evaluation of execution conditions for conditional reconfiguration(s), e.g., CHO, and only if the received HO Command is NOT a DAPS HO (i.e., only if no DAPS bearer is configured when the UE applies the Reconfiguration with sync), the UE stops the evaluation of conditional reconfiguration (e.g., stop the actions defined in 3GPP TS 38.331, § 5.3.5.13.4). In other words, the UE first determines whether the received HO command is a DAPS HO (i.e., contains at least one bearer configured with DAPS) to determine whether to stop the evaluation of conditional reconfiguration(s). If the HO Command does not correspond to a DAPS HO (it does not include a DAPS configuration for any of the bearer) the UE then stops the evaluation of conditional reconfiguration(s), if any.

However, if the HO Command does correspond to a DAPS HO (i.e., includes a DAPS configuration for at least one bearer), the UE does not stop the evaluation of conditional reconfiguration(s), if any. The UE may then instead stop the evaluation of the conditional reconfiguration(s) at a later point in time. In one alternative, the evaluation of the conditional reconfiguration(s) is stopped if the DAPS HO is considered successful (e.g., when timer T304 is stopped or at completion of the RACH procedure in the target cell). In another alternative, the evaluation of the conditional reconfiguration(s) is stopped when the DAPS HO procedure is completed, e.g. when the source cell of the DAPS HO is released.

With this solution, if the UE detects a HO failure in the DAPS HO procedure (e.g., by detecting that timer T304 expires for a HO that is configured with DAPS for at least one bearer), and radio link failure is not detected in the source PCell, i.e., a fallback to the source cell is triggered, then there is no need for the UE to then re-start the evaluation of conditional reconfiguration(s) (according to CHO configuration provided by source). This is since the evaluations have not, with this solution, been stopped since the HO was configured as a DAPS HO (i.e. with at least one DAPS bearer configured).

In one alternative the UE may, as an implementation aspect, pause the evaluation of the conditional reconfiguration(s) during the DAPS HO procedure, i.e., from reception of the HO Command configuring a DAPS HO until the DAPS fallback to the source cell occurs (due to DAPS HO failure and no radio link failure has been detected in the source cell) where the evaluations are performed again, or until the DAPS HO is considered successful or completed where the evaluations then are stopped.

This approach can be possibly specified in the RRC specification (e.g. 3GPP TS 38.331) as follows, where the stopping of the evaluation of conditional reconfiguration in sub-clause 5.3.5.5.2 is based on whether the received HO Command is a DAPS HO, and where the evaluation, in case of a DAPS HO, then instead is specified at completion of the Random Access procedure, when timer T304 is stopped, in sub-clause 5.3.5.3:
--------------begin proposed specification------------------------
   5.3.5.5.2 Reconfiguration with sync
   The UE shall perform the following actions to execute a reconfiguration with sync.
      1> if the AS security is not activated, perform the actions upon going to RRC_IDLE as specified in 5.3.11 with the release cause ‘other’ upon which the procedure ends;
      1> if no DAPS bearer is configured:
         2> stop timer T310 for the corresponding SpCell, if running;
         2> stop the evaluation of conditional reconfiguration (as defined in 5.3.5.13.4);
      2> if this procedure is executed for the MCG:
         2> if timer T316 is running;
         3> stop timer T316;
         3> clear the information included in VarRLF-Report, if any;
         2> resume MCG transmission, if suspended.
      1> stop timer T312 for the corresponding SpCell, if running;
      1> start timer T304 for the corresponding SpCell with the timer value set to t304, as included in the reconfigurationWithSync;
         . . .
      1> start synchronising to the DL of the target SpCell;
   . . .
   5.3.5.3 Reception of an RRCReconfiguration by the UE
   The UE shall perform the following actions upon reception of the RRCReconfiguration, or upon execution of the conditional reconfiguration (CHO or CPC):
      1> if the RRCReconfiguration is applied due to a conditional reconfiguration execution upon cell selection while timer T311 is running, as defined in 5.3.7.3:
         2> remove all the entries within VarConditionalReconfig, if any;
      1> if the RRCReconfiguration includes the daps-SourceRelease:
         2> release source SpCell configuration;
         2> reset the source MAC and release the source MAC configuration;
         2> for each DAPS bearer:
         3> release the RLC entity or entities as specified in TS 38.322 [4], clause 5.1.3, and the associated logical channel for the source SpCell;
         3> reconfigure the PDCP entity to release DAPS as specified in TS 38.323 [5];
         2> for each SRB:
         3> release the PDCP entity for the source SpCell;
         3> release the RLC entity as specified in TS 38.322 [4], clause 5.1.3, and the associated logical channel for the source SpCell;
         2> release the physical channel configuration for the source SpCell;
         2> discard the keys used in the source SpCell (the K_{gNB} key, the K_{RRCenc} key, the K_{RRCint} key, the K_{UPint} key and the K_{UPenc} key), if any;
   . . .
      1> if reconfigurationWithSync was included in spCellConfig of an MCG or SCG, and when MAC of an NR cell group successfully completes a Random Access procedure triggered above:
         2> stop timer T304 for that cell group;
         2> stop timer T310 for source SpCell if running;
         2> apply the parts of the CSI reporting configuration, the scheduling request configuration and the sounding RS configuration that do not require the UE to know the SFN of the respective target SpCell, if any;
         2> apply the parts of the measurement and the radio resource configuration that require the UE to know the SFN of the respective target SpCell (e.g. measurement gaps, periodic CQI reporting, scheduling request configuration, sounding RS configuration), if any, upon acquiring the SFN of that target SpCell;
         2> if the UE is configured with any DAPS bearer:
         3> stop the evaluation of conditional reconfiguration (as defined in 5.3.5.13.4);
         2> for each DRB configured as DAPS bearer, request uplink data switching to the PDCP entity, as specified in TS 38.323 [5];
         2> if the reconfigurationWithSync was included in spCellConfig of an MCG:
         3> if T390 is running.
         4> stop timer T390 for all access categories;
         4> perform the actions as specified in 5.3.14.4.
         3> if T350 is running.
         4> stop timer T350;
         3> if RRCReconfiguration does not include dedicatedSIB1-Delivery and
         3> if the active downlink BWP, which is indicated by the firstActiveDownlinkBWP-Id for the target SpCell of the MCG, has a common search space configured by searchSpaceSIB1:
         4> acquire the SIB1, which is scheduled as specified in TS 38.213 [13], of the target SpCell of the MCG;
         4> upon acquiring SIB1, perform the actions specified in clause 5.2.2.4.2;
         2> if the reconfigurationWithSync was included in spCellConfig of an MCG; or:
         2> if the reconfigurationWithSync was included in spCellConfig of an SCG and the CPC was configured
         3> remove all the entries within VarConditionalReconfig, if any;
         3> for each measId of the source SpCell configuration, if the associated reportConfig has a reportType set to condTriggerConfig:
         4> for the associated reportConfigId:
         5> remove the entry with the matching reportConfigId from the reportConfigList within the VarMeasConfig;
         4> if the associated measObjectId is only associated to a reportConfig with reportType set to cho-TriggerConfig:
         5> remove the entry with the matching measObjectId from the measObjectList within the VarMeasConfig;
         4> remove the entry with the matching measId from the measIdList within the VarMeasConfig;
         2> if reconfigurationWithSync was included in masterCellGroup or secondaryCellGroup; and
         2> if the UE transmitted a UEAssistanceInformation message for the corresponding cell group during the last 1 second, and the UE is still configured to provide UE assistance information for the corresponding cell group:
         3> initiate transmission of a UEAssistanceInformation message for the corresponding cell group in accordance with clause 5.7.4.3;
         2> if SIB12 is provided by the target PCell; and the UE transmitted a SidelinkUEInformationNR message indicating a change of NR sidelink communication related parameters relevant in target PCell (i.e. change of sl-RxInterestedFreqList or sl-TxResourceReqList) during the last 1 second preceding reception of the RRCReconfiguration message including reconfigurationWithSync in spCellConfig of an MCG:
         3> initiate transmission of the SidelinkUEInformationNR message in accordance with 5.8.3.3;
         2> the procedure ends.
      NOTE 3: The UE is only required to acquire broadcasted SIB1 if the UE can acquire it without disrupting unicast data reception, i.e. the broadcast and unicast beams are quasi co-located.
--------------end proposed specification------------------------

UE Embodiments—Upon DAPS Fallback, UE Indicates CHO is Stopped

In some embodiments, the UE receives a HO command including a DAPS configuration for at least one bearer, where the UE receives the HO command while the UE is performing the evaluation of execution conditions for CHO. Upon receiving this HO command, the UE stops the evaluation of conditional reconfiguration (e.g., stopping the actions defined in 3GPP TS 38.331, 5.3.5.13.4). Then, upon detecting a HO failure for the DAPS HO (e.g., by detecting that timer T304 expires for the HO that is configured with DAPS for at least one bearer) and if radio link failure is not detected in the source PCell, the UE performs the fallback to the source cell and transmits a Failure Information message indicating a DAPS failure to the source cell. The UE then includes an indication that evaluation of conditional reconfiguration(s), e.g., CHO configuration(s), is/are stopped (which may depend on UE implementation). This is transmitted so that source node is aware and can possibly re-activate evaluation of the conditional reconfiguration(s) (e.g., by removing and adding again) and/or change the conditional reconfiguration(s).

In corresponding network embodiments, the network receives a Failure Information message indicating a DAPS failure and including an indication that evaluations of conditional reconfiguration(s) are stopped (which may depend on UE implementation). This is transmitted so that the source node is aware and then can re-activate the evaluations (e.g., by removing and adding the configuration(s) again or by performing a modification of them). There could then be different options to re-active the evaluations of the conditional reconfiguration(s) that are stopped e.g. due to the DAPS fallback, such as the network transmits a message (e.g., RRCReconfiguration) including an indication that stopped CHO evaluations are to be resumed/re-started.

In some embodiments, the UE then receives a message (e.g., RRCReconfiguration) including an indication that stopped CHO evaluations are to be resumed/re-started. Upon reception, the UE resumes the evaluation of CHO conditions.

In some embodiments, the handling of the evaluation for a conditional reconfiguration is dependent on the content of the conditional configuration, e.g., the type of conditional configuration, such as whether it is a CHO, CPC or CPA configuration, the cell that the conditional configuration is applicable for, and/or the type of execution criteria that is configured for the conditional configuration. In one alternative the evaluation of the conditional reconfiguration is only stopped at execution of a handover if the conditional reconfiguration is a CHO or CPC but not a CPA. In another alternative, the UE only restarts evaluation of conditional reconfiguration(s), at DAPS fallback (when the evaluations have been stopped at the execution of DAPS HO) for conditional reconfigurations that do not include the target cell for the DAPS HO, i.e., for that cell the evaluation is not started. In one alternative, the conditional reconfiguration for that cell is then also released by the UE at the DAPS fallback.

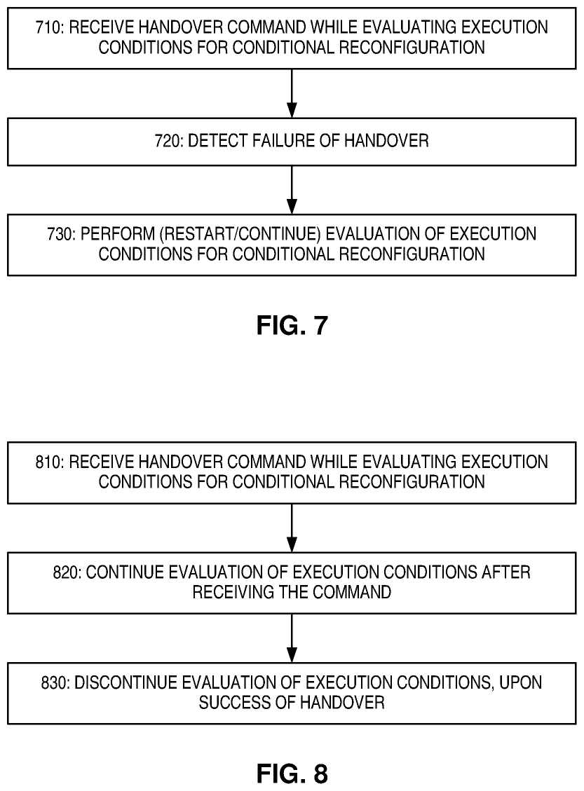

FIG. 7 illustrates an example method for handling a fallback after failure of a handover, such as a DAPS handover, as carried out by a user equipment. In view of the detailed description and examples provided above, it will be appreciated that the illustrated method may be considered to be a generalization of several of the techniques described above, and thus any of the variants of the corresponding techniques discussed above are applicable to the method shown in FIG. 7.

As shown at block 710, the method illustrated in FIG. 7 includes the step receiving a command instructing the UE to handover one or more radio bearers from a source cell to a target cell, where this command is received while the UE is evaluating execution conditions for a conditional reconfiguration. This command may be for a DAPS handover, in some embodiments or instances. The UE may be evaluating execution conditions for each of one or more conditional reconfigurations, of course, but only one is referred to here, to simplify the explanation. It should also be noted that the phrase “while the UE is evaluating execution conditions,” as used here and elsewhere within this document, should be understood as referring to an ongoing process which may be intermittent in nature. In other words, the requirement that the command for handover be received “while the UE is evaluating execution conditions for a conditional reconfiguration” does not mean that the receiving of the command is simultaneous with processing steps for evaluating those execution conditions, but instead means that the command is received during an interval of time when the UE is intermittently, e.g., periodically, evaluating these execution conditions pursuant to corresponding configuration information provided to the UE.

As shown at block 720, the illustrated method in FIG. 7 further comprises the step of detecting failure of the handover of at least one radio bearer from the source cell to the target cell. This may comprise, for example, detecting that timer T304 has expired. As shown at block 730, the method further comprises, in response to said detecting, performing evaluation of the execution conditions for the conditional reconfiguration.

Here, the phrase “performing evaluation of the execution conditions” is meant, in this and similar contexts, to refer to one of two possibilities. In a first set of embodiments of the method shown in FIG. 7, the UE stops evaluation of the execution conditions for the one or more conditional reconfigurations in response to receiving the command, but then re-starts evaluation of the execution conditions for the conditional reconfiguration in response to detecting the failure of the handover. In these embodiments, then, “performing evaluation of the execution conditions” in response to detecting the failure of the handover refers to the evaluation that occurs upon re-starting the evaluation. In these embodiments, the stopping of the evaluation of the execution conditions upon receipt of the handover command may be regarded as a suspension, in view of the subsequent re-starting.

In another set of embodiments, the UE continues evaluation of the execution conditions for the conditional reconfiguration after receiving the command—in other words, the UE does not stop or suspend the evaluation of the execution conditions in response to receiving the handover command. In some of these embodiments, this continuing of the evaluation of the execution conditions for the conditional configuration may be in response to determining that the received command configures a dual-active protocol stack, DAPS, handover of at least one of the one or more radio bearers.

In various embodiments or instances, the conditional reconfiguration may be any one of: a conditional handover, CHO, a conditional PSCell change, CPC, a conditional PSCell addition, CPA, and a conditional PSCell change/addition, CPAC. In some embodiments, the performing of the evaluation of the execution conditions for the conditional reconfiguration after detecting the handover failure is conditioned on the conditional configuration being of one or more particular types of conditional configuration. In some of these embodiments, for example, the performing evaluation of the execution conditions for the conditional reconfiguration may be conditioned on the conditional configuration being a CHO or CPC but not a CPA. In some embodiments, the performing evaluation of the execution conditions for the conditional reconfiguration may be conditioned on the conditional reconfiguration not including the target cell for the handover.

FIG. 8 illustrates another example method carried out by a UE, in this case where a handover, such as a DAPS handover, is successful. As shown at block 810, the method includes the step of receiving a command instructing the UE to handover one or more radio bearers from a source cell to a target cell, where the command is received while the UE is evaluating execution conditions for a conditional reconfiguration. As shown at block 820, the method comprises continuing evaluation of the execution conditions for the one or more conditional reconfigurations after receiving the command, in response to determining that the received command configures a dual-active protocol stack, DAPS, handover of at least one of the one or more radio bearers. As shown at block 830, the method still further comprises subsequently discontinuing evaluation of the execution conditions for the one or more conditional reconfigurations, in response to a successful handover. This discontinuing of the evaluation may be more specifically in response to for example, any of: completing a random access procedure in the target cell, releasing the source cell upon completion of the handover, and stopping of a timer in response to successful handover.

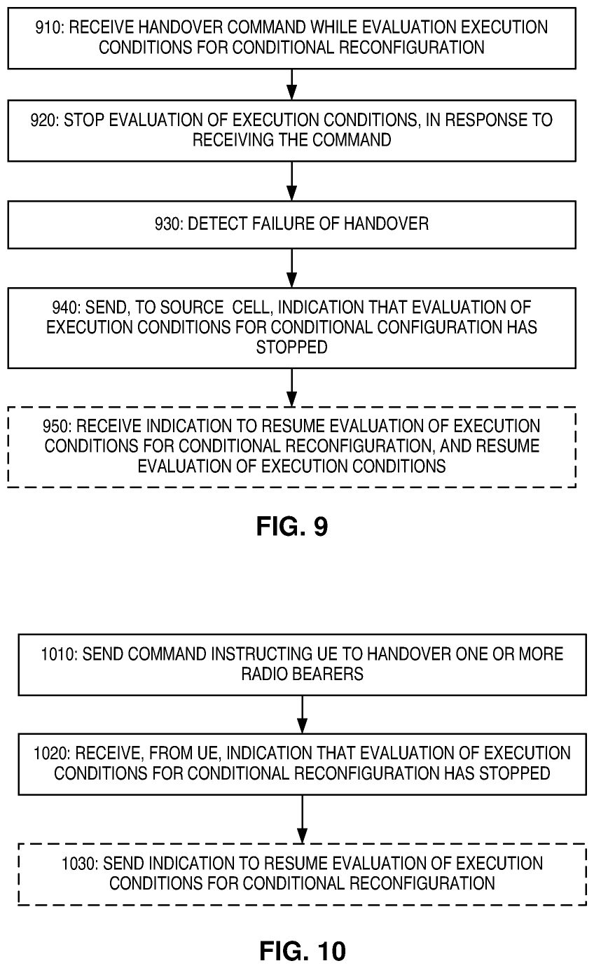

As was the case with the method shown in FIG. 8, in various embodiments or instances of the method shown in FIG. 9, the conditional reconfiguration may be one of: a conditional handover, CHO, a conditional PSCell change, CPC, a conditional PSCell addition, CPA, and a conditional PSCell change/addition, CPAC. In some embodiments, the continuing of the evaluation of the execution conditions for the conditional reconfiguration is conditioned on the conditional configuration being of one or more particular types of conditional configuration. Thus, for example, the continuing of the evaluation of the execution conditions for the conditional reconfiguration may be conditioned on the conditional configuration being a CHO or CPC but not a CPA. In some embodiments, the continuing of the evaluation of the execution conditions for the conditional reconfiguration may be conditioned on the conditional reconfiguration not including the target cell for the handover.

FIG. 9 illustrates another example method for handling a fallback after failure of a handover, such as a DAPS handover, as carried out by a user equipment. This may be viewed as an alternative to the approach illustrated generally in FIG. 7. As seen at block 910, this method, like the method shown in FIGS. 7 and 8, begins with the step of receiving a command instructing the UE to handover one or more radio bearers from a source cell to a target cell, where the command is received while the UE is evaluating execution conditions for a conditional reconfiguration. As shown at blocks 920 and 930, this method further includes the steps of stopping evaluation of the execution conditions for the conditional reconfiguration, in response to receiving the command, and detecting failure of the handover of at least one radio bearer from the source cell to the target cell.

In this method, however, instead of continuing or re-starting evaluation of the execution conditions in response to detecting the failure, the UE instead sends, to the source cell, an indication that evaluation of the execution conditions for the conditional reconfiguration has stopped. This is illustrated at block 940. This indication may be included in a Failure Information message indicating failure of the handover, for example.

In some embodiments or instances, the network may decide that the evaluation of the execution conditions for the conditional configuration should be re-started. Thus, in some embodiments, the method further comprises the steps of receiving, from the source cell, subsequent to sending the indication that evaluation of the execution conditions for the conditional reconfiguration has stopped, an indication to resume evaluation of the execution conditions for the conditional reconfiguration, and resuming evaluation of the execution conditions for the conditional reconfiguration, in response to receiving the indication from the source cell. These steps are shown at block 950.

As was the case with the methods shown in FIGS. 7 and 8, in the method shown in FIG. 9, the command may configure a dual-active protocol stack, DAPS, handover of at least one of the one or more radio bearers. In various embodiments, the conditional reconfiguration may be any one of: a conditional handover, CHO, a conditional PSCell change, CPC, a conditional PSCell addition, CPA, and a conditional PSCell change/addition, CPAC.

FIG. 10 illustrates an example method carried out by a network node serving a UE. This method may be understood as complementing the method shown in FIG. 9. As shown at block 1010, the method includes the step of sending a command instructing the UE to handover one or more radio bearers from a source cell to a target cell. This may be a command instructing a DAPS handover, for example. As shown at block 1020, the method further comprises receiving, from the UE, an indication that evaluation by the U E of execution conditions for a conditional reconfiguration configured for the UE has stopped. This indication may be included in a Failure Information message indicating failure of the handover, for example.

As discussed above, receipt of this indication allows the network node to consider whether evaluation of the execution conditions for the conditional configuration should be re-started. Thus, in some embodiments and/or instances, the method may further comprise sending, to the UE, subsequent to receiving the indication that evaluation of the execution conditions for the conditional reconfiguration has stopped, an indication to resume evaluation of the execution conditions for the conditional reconfiguration. This is shown at block 1030. As with the previously discussed methods, the conditional reconfiguration may be any one of: a conditional handover, CHO, a conditional PSCell change, CPC, a conditional PSCell addition, CPA, and a conditional PSCell change/addition, CPAC, for example.

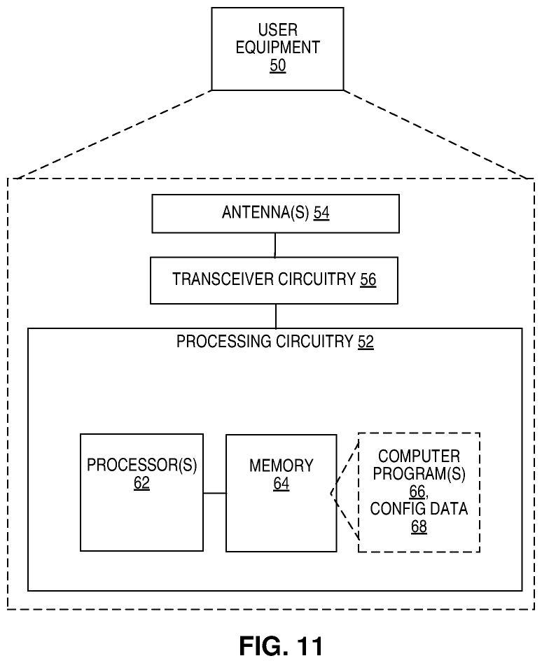

FIG. 11 illustrates a diagram of a user equipment 50 configured to carry out the techniques described above, according to some embodiments. User equipment 50 may be considered to represent any wireless devices or terminals that may operate in a network, such as a UE in a cellular network. Other examples may include a communication device, target device, MTC device, IoT device, device to device (D2D) UE, machine type UE or UE capable of machine to machine communication (M2M), a sensor equipped with UE, PDA (personal digital assistant), tablet, IPAD tablet, mobile terminal, smart phone, laptop embedded equipped (LEE), laptop mounted equipment (LME), USB dongles, Customer Premises Equipment (CPE), etc.

User equipment 50 is configured to communicate with a network node or base station in a wide-area cellular network via antennas 54 and transceiver circuitry 56. Transceiver circuitry 56 may include transmitter circuits, receiver circuits, and associated control circuits that are collectively configured to transmit and receive signals according to a radio access technology, for the purposes of using cellular communication services. This radio access technologies can be NR and LTE for the purposes of this discussion.

User equipment 50 also includes one or more processing circuits 52 that are operatively associated with the radio transceiver circuitry 56. Processing circuitry 52 comprises one or more digital processing circuits, e.g., one or more microprocessors, microcontrollers, DSPs, FPGAs, CPLDs, ASICs, or any mix thereof. More generally, processing circuitry 52 may comprise fixed circuitry, or programmable circuitry that is specially adapted via the execution of program instructions implementing the functionality taught herein, or may comprise some mix of fixed and programmed circuitry. Processing circuitry 52 may be multi-core.

Processing circuitry 52 also includes a memory 64. Memory 64, in some embodiments, stores one or more computer programs 66 and, optionally, configuration data 68. Memory 64 provides non-transitory storage for computer program 66 and it may comprise one or more types of computer-readable media, such as disk storage, solid-state memory storage, or any mix thereof. By way of non-limiting example, memory 64 comprises any one or more of SRAM, DRAM, EEPROM, and FLASH memory, which may be in processing circuitry 52 and/or separate from processing circuitry 52. Memory 64 may also store any configuration data 68 used by wireless device 50. Processing circuitry 52 may be configured, e.g., through the use of appropriate program code stored in memory 64, to carry out one or more of the methods and/or signaling processes detailed hereinafter.

Processing circuitry 52 of the user equipment 50 is configured, according to some embodiments, to perform any or all of the techniques described herein for a user equipment, including those techniques illustrated in FIGS. 7-9, and the variations described herein.

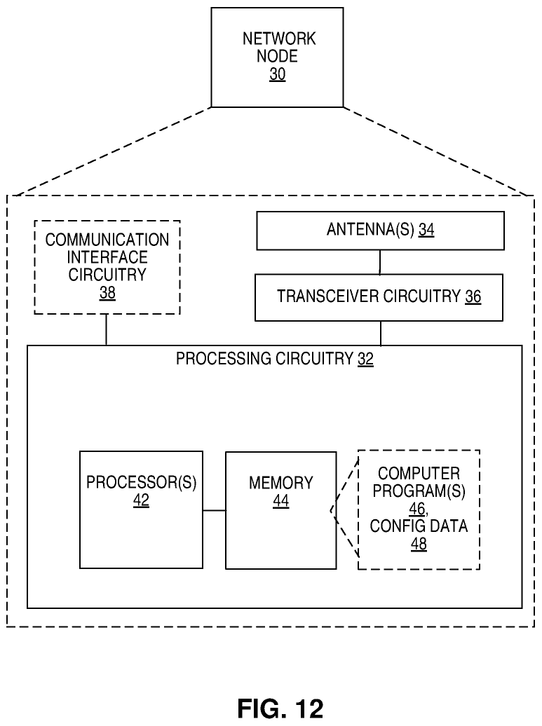

FIG. 12 shows an example network node 30 that may correspond to any of the access nodes described herein, whether acting as a target node or source node of a handover. Network node 30 may be configured to carry out one or more of these disclosed techniques. Network node 30 may be an evolved Node B (eNodeB), Node B or gNB. Network node may represent a radio network node such as base station, radio base station, base transceiver station, base station controller, network controller, NR BS, Multi-cell/multicast Coordination Entity (MCE), relay node, access point, radio access point, Remote Radio Unit (RRU) Remote Radio Head (RRH), or a multi-standard BS (MSR BS).

In the discussion herein, network node 30 is described as being configured to operate as a cellular network access node in an LTE network or NR network, but network node 30 may also correspond to similar access nodes in other types of network.

Those skilled in the art will readily appreciate how each type of node may be adapted to carry out one or more of the methods and signaling processes described herein, e.g., through the modification of and/or addition of appropriate program instructions for execution by processing circuits 32.

Network node 30 facilitates communication between wireless terminals (e.g., UEs), other network access nodes and/or the core network. Network node 30 may include communication interface circuitry 38 that includes circuitry for communicating with other nodes in the core network, radio nodes, and/or other types of nodes in the network for the purposes of providing data and/or cellular communication services. Network node 30 communicates with wireless devices using antennas 34 and transceiver circuitry 36. Transceiver circuitry 36 may include transmitter circuits, receiver circuits, and associated control circuits that are collectively configured to transmit and receive signals according to a radio access technology, for the purposes of providing cellular communication services.

Network node 30 also includes one or more processing circuits 32 that are operatively associated with the transceiver circuitry 36 and, in some cases, the communication interface circuitry 38. Processing circuitry 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, processing circuitry 32 may comprise fixed circuitry, or programmable circuitry that is specially configured via the execution of program instructions implementing the functionality taught herein, or some mix of fixed and programmed circuitry. Processor 42 may be multi-core, i.e., having two or more processor cores utilized for enhanced performance, reduced power consumption, and more efficient simultaneous processing of multiple tasks.

Processing circuitry 32 also includes a memory 44. Memory 44, in some embodiments, stores one or more computer programs 46 and, optionally, configuration data 48. Memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, memory 44 comprises any one or more of SRAM, DRAM, EEPROM, and FLASH memory, which may be in processing circuitry 32 and/or separate from processing circuitry 32. Memory 44 may also store any configuration data 48 used by the network access node 30. Processing circuitry 32 may be configured, e.g., through the use of appropriate program code stored in memory 44, to carry out one or more of the methods and/or signaling processes detailed hereinafter.

Processing circuitry 32 of the network node 30 is configured, according to some embodiments, to perform the techniques described herein for a network node, such as the first target node or second target node described in the several example techniques described above and illustrated in FIG. 10.

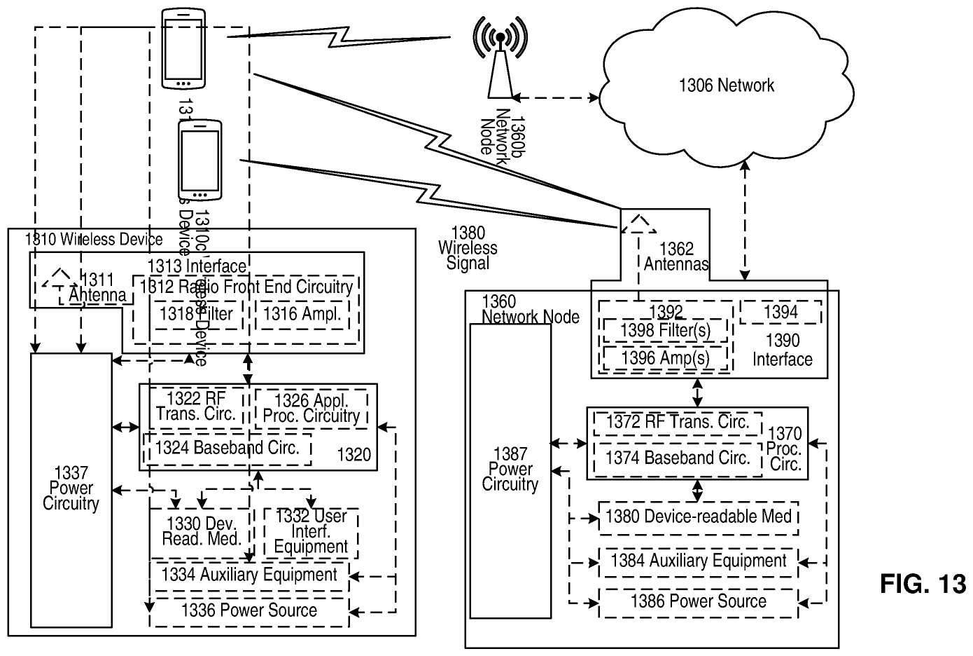

Although the subject matter described herein can be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c. In practice, a wireless network can further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1360 are depicted as single boxes located within a larger box, or nested within multiple boxes, in practice, a network node can comprise multiple different physical components that make up a single illustrated component (e.g., device readable medium 1380 can comprise multiple separate hard drives as well as multiple RAM modules).

Similarly, network node 1360 can be composed of multiple physically separate components (e.g., a NodeB component and a RNC component, or a BTS component and a BSC component, etc.), which can each have their own respective components. In certain scenarios in which network node 1360 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 1360 can be configured to support multiple radio access technologies (RATs). In such embodiments, some components can be duplicated (e.g., separate device readable medium 1380 for the different RATs) and some components can be reused (e.g., the same antenna 1362 can be shared by the RATs). Network node 1360 can also include multiple sets of the various illustrated components for different wireless technologies integrated into network node 1360, such as, for example, GSM, WCDMA, LTE, NR, WiFi, or Bluetooth wireless technologies. These wireless technologies can be integrated into the same or different chip or set of chips and other components within network node 1360.

Processing circuitry 1370 can be configured to perform any determining, calculating, or similar operations (e.g., certain obtaining operations) described herein as being provided by a network node. These operations performed by processing circuitry 1370 can include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 can execute instructions stored in device readable medium 1380 or in memory within processing circuitry 1370. Such functionality can include providing any of the various wireless features, functions, or benefits discussed herein. In some embodiments, processing circuitry 1370 can include a system on a chip (SOC).

In some embodiments, processing circuitry 1370 can include one or more of radio frequency (RF) transceiver circuitry 1372 and baseband processing circuitry 1374. In some embodiments, radio frequency (RF) transceiver circuitry 1372 and baseband processing circuitry 1374 can be on separate chips (or sets of chips), boards, or units, such as radio units and digital units. In alternative embodiments, part or all of RF transceiver circuitry 1372 and baseband processing circuitry 1374 can be on the same chip or set of chips, boards, or units

In certain embodiments, some or all of the functionality described herein as being provided by a network node, base station, eNB or other such network device can be performed by processing circuitry 1370 executing instructions stored on device readable medium 1380 or memory within processing circuitry 1370. In alternative embodiments, some or all of the functionality can be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1370. Device readable medium 1380 can store any suitable instructions, data or information, including a computer program, software, an application including one or more of logic, rules, code, tables, etc. and/or other instructions capable of being executed by processing circuitry 1370 and, utilized by network node 1360. Device readable medium 1380 can be used to store any calculations made by processing circuitry 1370 and/or any data received via interface 1390. In some embodiments, processing circuitry 1370 and device readable medium 1380 can be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that can be coupled to, or in certain embodiments a part of, antenna 1362. Radio front end circuitry 1392 comprises filters 1398 and amplifiers 1396. Radio front end circuitry 1392 can be connected to antenna 1362 and processing circuitry 1370. Radio front end circuitry can be configured to condition signals communicated between antenna 1362 and processing circuitry 1370. Radio front end circuitry 1392 can receive digital data that is to be sent out to other network nodes or WDs via a wireless connection. Radio front end circuitry 1392 can convert the digital data into a radio signal having the appropriate channel and bandwidth parameters using a combination of filters 1398 and/or amplifiers 1396. The radio signal can then be transmitted via antenna 1362. Similarly, when receiving data, antenna 1362 can collect radio signals which are then converted into digital data by radio front end circuitry 1392. The digital data can be passed to processing circuitry 1370. In other embodiments, the interface can comprise different components and/or different combinations of components.

In certain alternative embodiments, network node 1360 may not include separate radio front end circuitry 1392, instead, processing circuitry 1370 can comprise radio front end circuitry and can be connected to antenna 1362 without separate radio front end circuitry 1392. Similarly, in some embodiments, all or some of RF transceiver circuitry 1372 can be considered a part of interface 1390. In still other embodiments, interface 1390 can include one or more ports or terminals 1394, radio front end circuitry 1392, and RF transceiver circuitry 1372, as part of a radio unit (not shown), and interface 1390 can communicate with baseband processing circuitry 1374, which is part of a digital unit (not shown).

Antenna 1362 can include one or more antennas, or antenna arrays, configured to send and/or receive wireless signals. Antenna 1362 can be coupled to radio front end circuitry 1390 and can be any type of antenna capable of transmitting and receiving data and/or signals wirelessly. In some embodiments, antenna 1362 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 1362 can be separate from network node 1360 and can be connectable to network node 1360 through an interface or port.

Antenna 1362, interface 1390, and/or processing circuitry 1370 can be configured to perform any receiving operations and/or certain obtaining operations described herein as being performed by a network node. Any information, data and/or signals can be received from a wireless device, another network node and/or any other network equipment. Similarly, antenna 1362, interface 1390, and/or processing circuitry 1370 can be configured to perform any transmitting operations described herein as being performed by a network node. Any information, data and/or signals can be transmitted to a wireless device, another network node and/or any other network equipment.

Power circuitry 1387 can comprise, or be coupled to, power management circuitry and can be configured to supply the components of network node 1360 with power for performing the functionality described herein. Power circuitry 1387 can receive power from power source 1386. Power source 1386 and/or power circuitry 1387 can be configured to provide power to the various components of network node 1360 in a form suitable for the respective components (e.g., at a voltage and current level needed for each respective component). Power source 1386 can either be included in, or external to, power circuitry 1387 and/or network node 1360. For example, network node 1360 can be connectable to an external power source (e.g., an electricity outlet) via an input circuitry or interface such as an electrical cable, whereby the external power source supplies power to power circuitry 1387. As a further example, power source 1386 can comprise a source of power in the form of a battery or battery pack which is connected to, or integrated in, power circuitry 1387. The battery can provide backup power should the external power source fail. Other types of power sources, such as photovoltaic devices, can also be used.

Alternative embodiments of network node 1360 can include additional components beyond those shown in FIG. 13 that can be responsible for providing certain aspects of the network node's functionality, including any of the functionality described herein and/or any functionality necessary to support the subject matter described herein. For example, network node 1360 can include user interface equipment to allow and/or facilitate input of information into network node 1360 and to allow and/or facilitate output of information from network node 1360. This can allow and/or facilitate a user to perform diagnostic, maintenance, repair, and other administrative functions for network node 1360.

In some embodiments, a wireless device (WD, e.g. WD 1310) can be configured to communicate wirelessly with network nodes (e.g., 1360) and/or other wireless devices (e.g., 1310b,c). Communicating wirelessly can involve transmitting and/or receiving wireless signals using electromagnetic waves, radio waves, infrared waves, and/or other types of signals suitable for conveying information through air. In some embodiments, a WD can be configured to transmit and/or receive information without direct human interaction. For instance, a WD can be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements, and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 can include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies can be integrated into the same or different chips or set of chips as other components within WD 1310.

Antenna 1311 can include one or more antennas or antenna arrays, configured to send and/or receive wireless signals, and is connected to interface 1314. In certain alternative embodiments, antenna 1311 can be separate from WD 1310 and be connectable to WD 1310 through an interface or port. Antenna 1311, interface 1314, and/or processing circuitry 1320 can be configured to perform any receiving or transmitting operations described herein as being performed by a WD. Any information, data and/or signals can be received from a network node and/or another WD. In some embodiments, radio front end circuitry and/or antenna 1311 can be considered an interface.

As illustrated, interface 1314 comprises radio front end circuitry 1312 and antenna 1311. Radio front end circuitry 1312 comprise one or more filters 1318 and amplifiers 1316. Radio front end circuitry 1314 is connected to antenna 1311 and processing circuitry 1320, and can be configured to condition signals communicated between antenna 1311 and processing circuitry 1320. Radio front end circuitry 1312 can be coupled to or a part of antenna 1311. In some embodiments, WD 1310 may not include separate radio front end circuitry 1312; rather, processing circuitry 1320 can comprise radio front end circuitry and can be connected to antenna 1311. Similarly, in some embodiments, some or all of RF transceiver circuitry 1322 can be considered a part of interface 1314. Radio front end circuitry 1312 can receive digital data that is to be sent out to other network nodes or WDs via a wireless connection. Radio front end circuitry 1312 can convert the digital data into a radio signal having the appropriate channel and bandwidth parameters using a combination of filters 1318 and/or amplifiers 1316. The radio signal can then be transmitted via antenna 1311. Similarly, when receiving data, antenna 1311 can collect radio signals which are then converted into digital data by radio front end circuitry 1312. The digital data can be passed to processing circuitry 1320. In other embodiments, the interface can comprise different components and/or different combinations of components.

Processing circuitry 1320 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality can include providing any of the various wireless features or benefits discussed herein. For example, processing circuitry 1320 can execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry can comprise different components and/or different combinations of components. In certain embodiments processing circuitry 1320 of WD 1310 can comprise a SOC. In some embodiments, RF transceiver circuitry 1322, baseband processing circuitry 1324, and application processing circuitry 1326 can be on separate chips or sets of chips. In alternative embodiments, part or all of baseband processing circuitry 1324 and application processing circuitry 1326 can be combined into one chip or set of chips, and RF transceiver circuitry 1322 can be on a separate chip or set of chips. In still alternative embodiments, part or all of RF transceiver circuitry 1322 and baseband processing circuitry 1324 can be on the same chip or set of chips, and application processing circuitry 1326 can be on a separate chip or set of chips. In yet other alternative embodiments, part or all of RF transceiver circuitry 1322, baseband processing circuitry 1324, and application processing circuitry 1326 can be combined in the same chip or set of chips. In some embodiments, RF transceiver circuitry 1322 can be a part of interface 1314. RF transceiver circuitry 1322 can condition RF signals for processing circuitry 1320.

In certain embodiments, some or all of the functionality described herein as being performed by a WD can be provided by processing circuitry 1320 executing instructions stored on device readable medium 1330, which in certain embodiments can be a computer-readable storage medium. In alternative embodiments, some or all of the functionality can be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 can be configured to perform any determining, calculating, or similar operations (e.g., certain obtaining operations) described herein as being performed by a WD. These operations, as performed by processing circuitry 1320, can include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 can be operable to store a computer program, software, an application including one or more of logic, rules, code, tables, etc. and/or other instructions capable of being executed by processing circuitry 1320. Device readable medium 1330 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1320. In some embodiments, processing circuitry 1320 and device readable medium 1330 can be considered to be integrated.

User interface equipment 1332 can include components that allow and/or facilitate a human user to interact with WD 1310. Such interaction can be of many forms, such as visual, audial, tactile, etc. User interface equipment 1332 can be operable to produce output to the user and to allow and/or facilitate the user to provide input to WD 1310. The type of interaction can vary depending on the type of user interface equipment 1332 installed in WD 1310. For example, if WD 1310 is a smart phone, the interaction can be via a touch screen; if WD 1310 is a smart meter, the interaction can be through a screen that provides usage (e.g., the number of gallons used) or a speaker that provides an audible alert (e.g., if smoke is detected). User interface equipment 1332 can include input interfaces, devices and circuits, and output interfaces, devices and circuits. User interface equipment 1332 can be configured to allow and/or facilitate input of information into WD 1310, and is connected to processing circuitry 1320 to allow and/or facilitate processing circuitry 1320 to process the input information. User interface equipment 1332 can include, for example, a microphone, a proximity or other sensor, keys/buttons, a touch display, one or more cameras, a USB port, or other input circuitry. User interface equipment 1332 is also configured to allow and/or facilitate output of information from WD 1310, and to allow and/or facilitate processing circuitry 1320 to output information from WD 1310. User interface equipment 1332 can include, for example, a speaker, a display, vibrating circuitry, a USB port, a headphone interface, or other output circuitry. Using one or more input and output interfaces, devices, and circuits, of user interface equipment 1332, WD 1310 can communicate with end users and/or the wireless network, and allow and/or facilitate them to benefit from the functionality described herein.

Auxiliary equipment 1334 is operable to provide more specific functionality which may not be generally performed by WDs. This can comprise specialized sensors for doing measurements for various purposes, interfaces for additional types of communication such as wired communications etc. The inclusion and type of components of auxiliary equipment 1334 can vary depending on the embodiment and/or scenario.

Power source 1336 can, in some embodiments, be in the form of a battery or battery pack. Other types of power sources, such as an external power source (e.g., an electricity outlet), photovoltaic devices or power cells, can also be used. WD 1310 can further comprise power circuitry 1337 for delivering power from power source 1336 to the various parts of WD 1310 which need power from power source 1336 to carry out any functionality described or indicated herein. Power circuitry 1337 can in certain embodiments comprise power management circuitry. Power circuitry 1337 can additionally or alternatively be operable to receive power from an external power source; in which case WD 1310 can be connectable to the external power source (such as an electricity outlet) via input circuitry or an interface such as an electrical power cable. Power circuitry 1337 can also in certain embodiments be operable to deliver power from an external power source to power source 1336. This can be, for example, for the charging of power source 1336. Power circuitry 1337 can perform any converting or other modification to the power from power source 1336 to make it suitable for supply to the respective components of WD 1310.

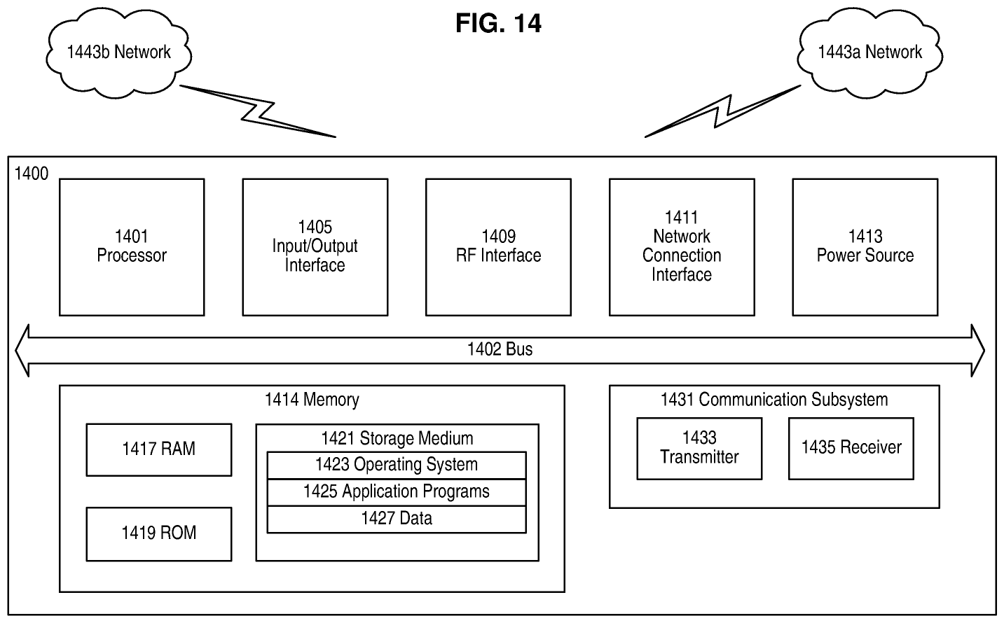

FIG. 14 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 1400 can be any UE identified by the 3rd Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE can be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 917, read-only memory (ROM) 919, and storage medium 921 or the like, communication subsystem 931, power source 933, and/or any other component, or any combination thereof. Storage medium 1421 includes operating system 1423, application program 1425, and data 1427. In other embodiments, storage medium 1421 can include other similar types of information. Certain UEs can utilize all of the components shown in FIG. 14, or only a subset of the components. The level of integration between the components can vary from one UE to another UE. Further, certain UEs can contain multiple instances of a component, such as multiple processors, memories, transceivers, transmitters, receivers, etc.

In FIG. 14, processing circuitry 1401 can be configured to process computer instructions and data. Processing circuitry 1401 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 can include two central processing units (CPUs). Data can be information in a form suitable for use by a computer.

In the depicted embodiment, input/output interface 1405 can be configured to provide a communication interface to an input device, output device, or input and output device. UE 1400 can be configured to use an output device via input/output interface 1405. An output device can use the same type of interface port as an input device. For example, a USB port can be used to provide input to and output from UE 1400. The output device can be a speaker, a sound card, a video card, a display, a monitor, a printer, an actuator, an emitter, a smartcard, another output device, or any combination thereof. UE 1400 can be configured to use an input device via input/output interface 1405 to allow and/or facilitate a user to capture information into UE 1400. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 14, RF interface 1409 can be configured to provide a communication interface to RF components such as a transmitter, a receiver, and an antenna. Network connection interface 1411 can be configured to provide a communication interface to network 1443a. Network 1443a can encompass wired and/or wireless networks such as a local-area network (LAN), a wide-area network (WAN), a computer network, a wireless network, a telecommunications network, another like network or any combination thereof. For example, network 1443a can comprise a Wi-Fi network. Network connection interface 1411 can be configured to include a receiver and a transmitter interface used to communicate with one or more other devices over a communication network according to one or more communication protocols, such as Ethernet, TCP/IP, SONET, ATM, or the like. Network connection interface 1411 can implement receiver and transmitter functionality appropriate to the communication network links (e.g., optical, electrical, and the like). The transmitter and receiver functions can share circuit components, software or firmware, or alternatively can be implemented separately.

RAM 1417 can be configured to interface via bus 1402 to processing circuitry 1401 to provide storage or caching of data or computer instructions during the execution of software programs such as the operating system, application programs, and device drivers. ROM 1419 can be configured to provide computer instructions or data to processing circuitry 1401. For example, ROM 1419 can be configured to store invariant low-level system code or data for basic system functions such as basic input and output (I/O), startup, or reception of keystrokes from a keyboard that are stored in a non-volatile memory. Storage medium 1421 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 can be configured to include operating system 1423, application program 1425 such as a web browser application, a widget or gadget engine or another application, and data file 1427. Storage medium 1421 can store, for use by UE 1400, any of a variety of various operating systems or combinations of operating systems.

Storage medium 1421 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 can allow and/or facilitate UE 1400 to access computer-executable instructions, application programs or the like, stored on transitory or non-transitory memory media, to off-load data, or to upload data. An article of manufacture, such as one utilizing a communication system can be tangibly embodied in storage medium 1421, which can comprise a device readable medium.

In FIG. 14, processing circuitry 1401 can be configured to communicate with network 1443b using communication subsystem 1431. Network 1443a and network 1443b can be the same network or networks or different network or networks. Communication subsystem 1431 can be configured to include one or more transceivers used to communicate with network 1443b. For example, communication subsystem 1431 can be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver can include transmitter 1433 and/or receiver 1435 to implement transmitter or receiver functionality, respectively, appropriate to the RAN links (e.g., frequency allocations and the like). Further, transmitter 1433 and receiver 1435 of each transceiver can share circuit components, software or firmware, or alternatively can be implemented separately.

In the illustrated embodiment, the communication functions of communication subsystem 1431 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 can include cellular communication, Wi-Fi communication, Bluetooth communication, and GPS communication. Network 1443b can encompass wired and/or wireless networks such as a local-area network (LAN), a wide-area network (WAN), a computer network, a wireless network, a telecommunications network, another like network or any combination thereof. For example, network 1443b can be a cellular network, a Wi-Fi network, and/or a near-field network. Power source 1413 can be configured to provide alternating current (AC) or direct current (DC) power to components of UE 1400.

The features, benefits and/or functions described herein can be implemented in one of the components of UE 1400 or partitioned across multiple components of UE 1400. Further, the features, benefits, and/or functions described herein can be implemented in any combination of hardware, software or firmware. In one example, communication subsystem 1431 can be configured to include any of the components described herein. Further, processing circuitry 1401 can be configured to communicate with any of such components over bus 1402. In another example, any of such components can be represented by program instructions stored in memory that when executed by processing circuitry 1401 perform the corresponding functions described herein. In another example, the functionality of any of such components can be partitioned between processing circuitry 1401 and communication subsystem 1431. In another example, the non-computationally intensive functions of any of such components can be implemented in software or firmware and the computationally intensive functions can be implemented in hardware.

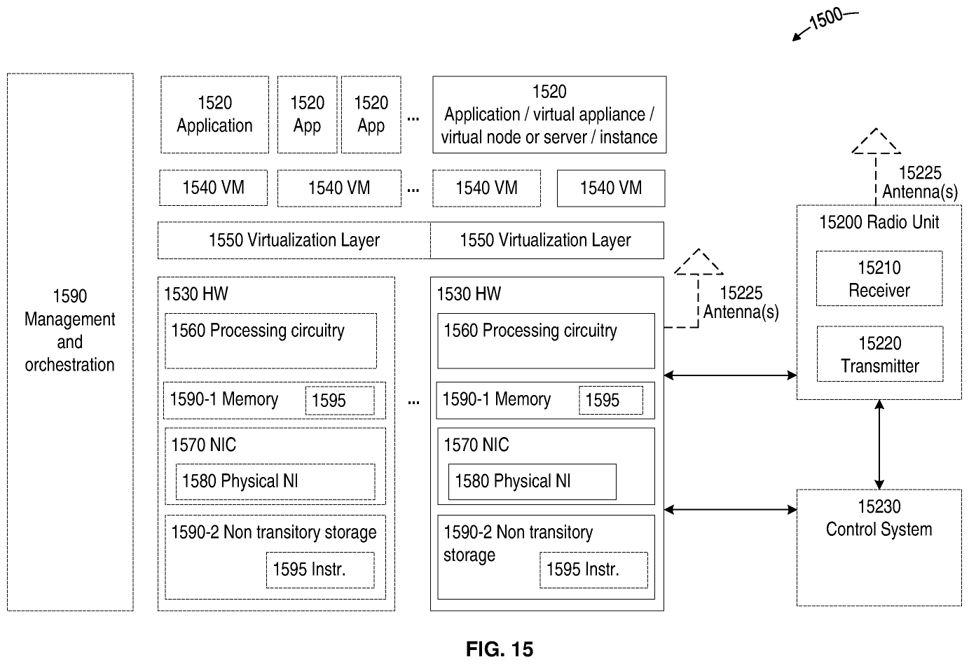

FIG. 15 is a schematic block diagram illustrating a virtualization environment 1500 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station, a virtualized radio access node, virtualized core network node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node can be entirely virtualized.

The functions can be implemented by one or more applications 1520 (which can alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which can be commercial off-the-shelf (COTS) processors, dedicated Application Specific Integrated Circuits (ASICs), or any other type of processing circuitry including digital or analog hardware components or special purpose processors. Each hardware device can comprise memory 1590-1 which can be non-persistent memory for temporarily storing instructions 1595 or software executed by processing circuitry 1560. Each hardware device can comprise one or more network interface controllers (NICs) 1570, also known as network interface cards, which include physical network interface 1580. Each hardware device can also include non-transitory, persistent, machine-readable storage media 1590-2 having stored therein software 1595 and/or instructions executable by processing circuitry 1560. Software 1595 can include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and can be run by a corresponding virtualization layer 1550 or hypervisor. Different embodiments of the instance of virtual appliance 1520 can be implemented on one or more of virtual machines 1540, and the implementations can be made in different ways.

During operation, processing circuitry 1560 executes software 1595 to instantiate the hypervisor or virtualization layer 1550, which can sometimes be referred to as a virtual machine monitor (VMM). Virtualization layer 1550 can present a virtual operating platform that appears like networking hardware to virtual machine 1540.

As shown in FIG. 15, hardware 1530 can be a standalone network node with generic or specific components. Hardware 1530 can comprise antenna 15225 and can implement some functions via virtualization. Alternatively, hardware 1530 can be part of a larger cluster of hardware (e.g., such as in a data center or customer premise equipment (CPE)) where many hardware nodes work together and are managed via management and orchestration (MANO) 1590, which, among others, oversees lifecycle management of applications 1520.

Virtualization of the hardware is in some contexts referred to as network function virtualization (NFV). NFV can be used to consolidate many network equipment types onto industry standard high-volume server hardware, physical switches, and physical storage, which can be located in data centers, and customer premise equipment.

In the context of NFV, virtual machine 1540 can be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

In the context of NFV, Virtual Network Function (VNF) is responsible for handling specific network functions that run in one or more virtual machines 1540 on top of hardware networking infrastructure 1530, and can correspond to application 1520 in FIG. 15.

In some embodiments, one or more radio units 15200 that each include one or more transmitters 15220 and one or more receivers 15210 can be coupled to one or more antennas 15225. Radio units 15200 can communicate directly with hardware nodes 1530 via one or more appropriate network interfaces and can be used in combination with the virtual components to provide a virtual node with radio capabilities, such as a radio access node or a base station.

In some embodiments, some signaling can be affected with the use of control system 15230 which can alternatively be used for communication between the hardware nodes 1530 and radio units 15200.

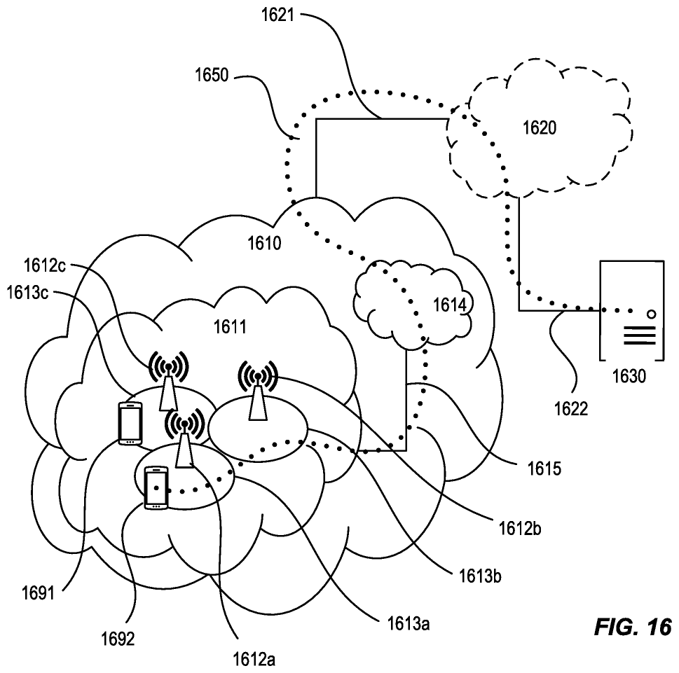

With reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c can be configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the

Telecommunication network 1610 is itself connected to host computer 1630, which can be embodied in the hardware and/or software of a standalone server, a cloud-implemented server, a distributed server or as processing resources in a server farm. Host computer 1630 can be under the ownership or control of a service provider, or can be operated by the service provider or on behalf of the service provider. Connections 1621 and 1622 between telecommunication network 1610 and host computer 1630 can extend directly from core network 1614 to host computer 1630 or can go via an optional intermediate network 1620. Intermediate network 1620 can be one of, or a combination of more than one of, a public, private or hosted network; intermediate network 1620, if any, can be a backbone network or the Internet; in particular, intermediate network 1620 can comprise two or more sub-networks (not shown).

The communication system of FIG. 16 as a whole enables connectivity between the connected UEs 1691, 1692 and host computer 1630. The connectivity can be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 can be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

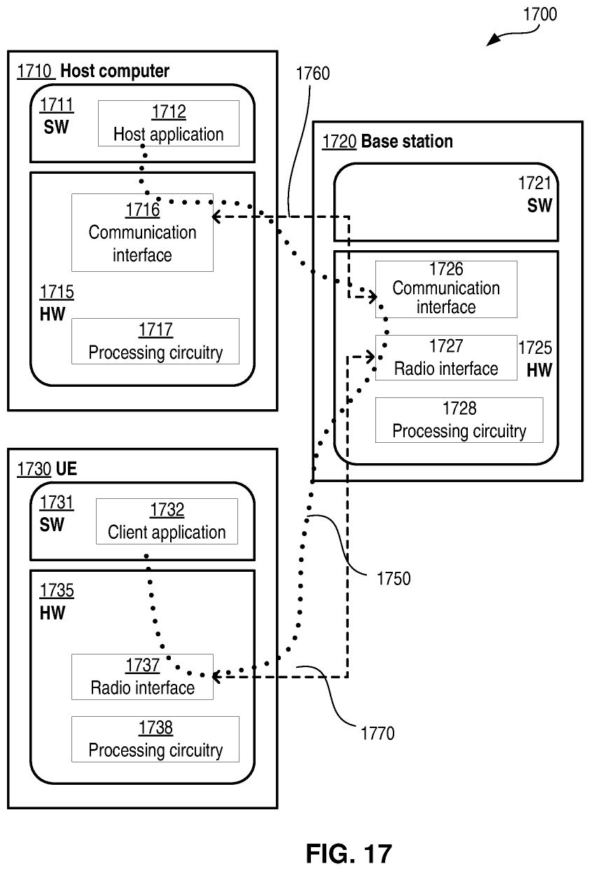

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which can have storage and/or processing capabilities. In particular, processing circuitry 1718 can comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 can be operable to provide a service to a remote user, such as UE 1730 connecting via OTT connection 1750 terminating at UE 1730 and host computer 1710. In providing the service to the remote user, host application 1712 can provide user data which is transmitted using OTT connection 1750.

Communication system 1700 can also include base station 1720 provided in a telecommunication system and comprising hardware 1725 enabling it to communicate with host computer 1710 and with UE 1730. Hardware 1725 can include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 can be configured to facilitate connection 1760 to host computer 1710. Connection 1760 can be direct or it can pass through a core network (not shown in FIG. 17) of the telecommunication system and/or through one or more intermediate networks outside the telecommunication system. In the embodiment shown, hardware 1725 of base station 1720 can also include processing circuitry 1728, which can comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 can also include UE 1730 already referred to. Its hardware 1735 can include radio interface 1737 configured to set up and maintain wireless connection 1770 with a base station serving a coverage area in which UE 1730 is currently located. Hardware 1735 of UE 1730 can also include processing circuitry 1738, which can comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 can be operable to provide a service to a human or non-human user via UE 1730, with the support of host computer 1710. In host computer 1710, an executing host application 1712 can communicate with the executing client application 1732 via OTT connection 1750 terminating at UE 1730 and host computer 1710. In providing the service to the user, client application 1732 can receive request data from host application 1712 and provide user data in response to the request data. OTT connection 1750 can transfer both the request data and the user data. Client application 1732 can interact with the user to generate the user data that it provides.

It is noted that host computer 1710, base station 1720 and UE 1730 illustrated in FIG. 17 can be similar or identical to host computer 1630, one of base stations 1612a, 1612b, 1612c and one of UEs 1691, 1692 of FIG. 16, respectively. This is to say, the inner workings of these entities can be as shown in FIG. 17 and independently, the surrounding network topology can be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure can determine the routing, which it can be configured to hide from UE 1730 or from the service provider operating host computer 1710, or both. While OTT connection 1750 is active, the network infrastructure can further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment. More precisely, the exemplary embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 1750 between host computer 1710 and UE 1730, in response to variations in the measurement results. The measurement procedure and/or the network functionality for reconfiguring OTT connection 1750 can be implemented in software 1711 and hardware 1715 of host computer 1710 or in software 1731 and hardware 1735 of UE 1730, or both. In embodiments, sensors (not shown) can be deployed in or in association with communication devices through which OTT connection 1750 passes; the sensors can participate in the measurement procedure by supplying values of the monitored quantities exemplified above, or supplying values of other physical quantities from which software 1711, 1731 can compute or estimate the monitored quantities. The reconfiguring of OTT connection 1750 can include message format, retransmission settings, preferred routing etc.; the reconfiguring need not affect base station 1720, and it can be unknown or imperceptible to base station 1720. Such procedures and functionalities can be known and practiced in the art. In certain embodiments, measurements can involve proprietary UE signaling facilitating host computer 1710's measurements of throughput, propagation times, latency and the like. The measurements can be implemented in that software 1711, 1731 causes messages to be transmitted, in particular empty or ‘dummy’ messages, using OTT connection 1750 while it monitors propagation times, errors etc.

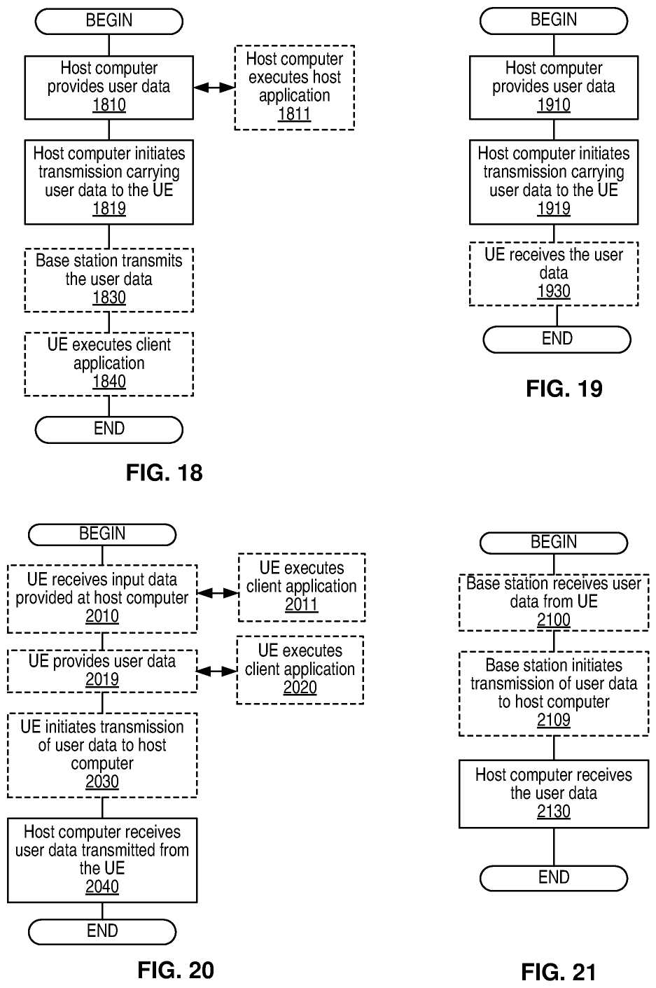

FIG. 18 is a flowchart illustrating an exemplary method and/or procedure implemented in a communication system, in accordance with one embodiment. The communication system includes a host computer, a base station and a UE which, in some exemplary embodiments, can be those described with reference to FIGS. 16 and 17. For simplicity of the present disclosure, only drawing references to FIG. 18 will be included in this section. In step 1810, the host computer provides user data. In substep 1811 (which can be optional) of step 1810, the host computer provides the user data by executing a host application. In step 1820, the host computer initiates a transmission carrying the user data to the UE. In step 1830 (which can be optional), the base station transmits to the UE the user data which was carried in the transmission that the host computer initiated, in accordance with the teachings of the embodiments described throughout this disclosure. In step 1840 (which can also be optional), the UE executes a client application associated with the host application executed by the host computer.

FIG. 19 is a flowchart illustrating an exemplary method and/or procedure implemented in a communication system, in accordance with one embodiment. The communication system includes a host computer, a base station and a UE which can be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission can pass via the base station, in accordance with the teachings of the embodiments described throughout this disclosure. In step 1930 (which can be optional), the UE receives the user data carried in the transmission.

FIG. 20 is a flowchart illustrating an exemplary method and/or procedure implemented in a communication system, in accordance with one embodiment. The communication system includes a host computer, a base station and a UE which can be those described with reference to FIGS. 16 and 17. For simplicity of the present disclosure, only drawing references to FIG. 20 will be included in this section. In step 2010 (which can be optional), the UE receives input data provided by the host computer. Additionally or alternatively, in step 2020, the UE provides user data. In substep 2021 (which can be optional) of step 2020, the UE provides the user data by executing a client application. In substep 2011 (which can be optional) of step 2010, the UE executes a client application which provides the user data in reaction to the received input data provided by the host computer. In providing the user data, the executed client application can further consider user input received from the user. Regardless of the specific manner in which the user data was provided, the UE initiates, in substep 2030 (which can be optional), transmission of the user data to the host computer. In step 2040 of the method, the host computer receives the user data transmitted from the UE, in accordance with the teachings of the embodiments described throughout this disclosure.

FIG. 21 is a flowchart illustrating an exemplary method and/or procedure implemented in a communication system, in accordance with one embodiment. The communication system includes a host computer, a base station and a UE which can be those described with reference to FIGS. 16 and 17. For simplicity of the present disclosure, only drawing references to FIG. 21 will be included in this section. In step 2110 (which can be optional), in accordance with the teachings of the embodiments described throughout this disclosure, the base station receives user data from the UE. In step 2120 (which can be optional), the base station initiates transmission of the received user data to the host computer. In step 2130 (which can be optional), the host computer receives the user data carried in the transmission initiated by the base station.

The exemplary embodiments described herein provide techniques for pre-configuring a UE for operation in a 3GPP non-terrestrial network (NTN). Such embodiments reduce the time needed for initial acquisition of an NTN (e.g., PLMN) and a cell within the NTN. This can provide various benefits and/or advantages, including reducing UE energy consumption (or, equivalently, increasing UE operational time on one battery charge) and improving user access to services provided by an NTN. When used in UEs and/or network nodes, exemplary embodiments described herein can enable UEs to access network resources and OTT services more consistently and without interruption. This improves the availability and/or performance of these services as experienced by OTT service providers and end-users, including more consistent data throughout and fewer delays without excessive UE power consumption or other reductions in user experience.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that while these words and/or other words that can be synonymous to one another can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### Example Embodiments

Embodiments of the presently disclosed techniques and apparatuses include, but are not limited to, the following enumerated examples:

1. A method, in a user equipment, UE, the method comprising:
receiving a command instructing the UE to handover one or more radio bearers from a source cell to a target cell, wherein the command is received while the UE is evaluating execution conditions for a conditional reconfiguration;
detecting failure of the handover of at least one radio bearer from the source cell to the target cell; and,
in response to said detecting, performing evaluation of the execution conditions for the conditional reconfiguration.

2. The method of example embodiment 1, wherein the method comprises:
stopping evaluation of the execution conditions for the one or more conditional reconfigurations in response to receiving the command; and
re-starting evaluation of the execution conditions for the conditional reconfiguration in response to detecting the failure of the handover.

3. The method of example embodiment 1 or 2, wherein the command configures a dual-active protocol stack, DAPS, handover of at least one of the one or more radio bearers.

4. The method of example embodiment 1, wherein the method comprises continuing evaluation of the execution for the conditional reconfiguration after receiving the command, in response to determining that the received command configures a dual-active protocol stack, DAPS, handover of at least one of the one or more radio bearers.

5. The method of any of example embodiments 1-4, wherein the conditional reconfiguration is one of: a conditional handover, CHO, a conditional PSCell change, CPC, a conditional PSCell addition, CPA, and a conditional PSCell change/addition, CPAC.

6. The method of any of example embodiments 1-5, wherein said performing evaluation of the execution conditions for the conditional reconfiguration is conditioned on the conditional configuration being of one or more particular types of conditional configuration.

7. The method of example embodiment 6, wherein said performing evaluation of the execution conditions for the conditional reconfiguration is conditioned on the conditional configuration being a CHO or CPC but not a CPA.

8. The method of any of example embodiments 1-7, wherein said performing evaluation of the execution conditions for the conditional reconfiguration is conditioned on the conditional reconfiguration not including the target cell for the handover.

9. A method, in a user equipment, UE, the method comprising:
receiving a command instructing the UE to handover one or more radio bearers from a source cell to a target cell, wherein the command is received while the UE is evaluating execution conditions for a conditional reconfiguration;
continuing evaluation of the execution conditions for the one or more conditional reconfigurations after receiving the command, in response to determining that the received command configures a dual-active protocol stack, DAPS, handover of at least one of the one or more radio bearers; and
subsequently discontinuing evaluation of the execution conditions for the one or more conditional reconfigurations, in response to one of: completing a random access procedure in the target cell, releasing the source cell upon completion of the handover, and stopping of a timer in response to successful handover.

10. The method of example embodiment 9, wherein the conditional reconfiguration is one of: a conditional handover, CHO, a conditional PSCell change, CPC, a conditional PSCell addition, CPA, and a conditional PSCell change/addition, CPAC.

11. The method of example embodiment 9 or 10, wherein said continuing evaluation of the execution conditions for the conditional reconfiguration is conditioned on the conditional configuration being of one or more particular types of conditional configuration.

12. The method of example embodiment 11, wherein said continuing evaluation of the execution conditions for the conditional reconfiguration is conditioned on the conditional configuration being a CHO or CPC but not a CPA.

13. The method of any of example embodiments 9-11, wherein said continuing evaluation of the execution conditions for the conditional reconfiguration is conditioned on the conditional reconfiguration not including the target cell for the handover.

14. A method, in a user equipment, UE, the method comprising:
receiving a command instructing the UE to handover one or more radio bearers from a source cell to a target cell, wherein the command is received while the UE is evaluating execution conditions for a conditional reconfiguration;
stopping evaluation of the execution conditions for the conditional reconfiguration, in response to receiving the command;
detecting failure of the handover of at least one radio bearer from the source cell to the target cell; and,
in response to said detecting, sending, to the source cell, an indication that evaluation of the execution conditions for the conditional reconfiguration has stopped.

15. The method of example embodiment 14, wherein the indication is included in a Failure Information message indicating failure of the handover.

16. The method of example embodiment 14 or 15, further comprising:
receiving, from the source cell, subsequent to sending the indication that evaluation of the execution conditions for the conditional reconfiguration has stopped, an indication to resume evaluation of the execution conditions for the conditional reconfiguration; and
resuming evaluation of the execution conditions for the conditional reconfiguration, in response to receiving the indication from the source cell.

17. The method of any of example embodiments 14-16, wherein the command configures a dual-active protocol stack, DAPS, handover of at least one of the one or more radio bearers.

18. The method of any of example embodiments 14-17, wherein the conditional reconfiguration is one of: a conditional handover, CHO, a conditional PSCell change, CPC, a conditional PSCell addition, CPA, and a conditional PSCell change/addition, CPAC.

19. A method, in a network node serving a user equipment, UE, the method comprising:
sending a command instructing the UE to handover one or more radio bearers from a source cell to a target cell; and
receiving, from the UE, an indication that evaluation by the UE of execution conditions for a conditional reconfiguration configured for the UE has stopped.

20. The method of example embodiment 19, wherein the indication is included in a Failure Information message indicating failure of the handover.

21. The method of example embodiment 19 or 20, further comprising:
sending, to the UE, subsequent to receiving the indication that evaluation of the execution conditions for the conditional reconfiguration has stopped, an indication to resume evaluation of the execution conditions for the conditional reconfiguration.

22. The method of any of example embodiments 19-21, wherein the command configures a dual-active protocol stack, DAPS, handover of at least one of the one or more radio bearers.

23. The method of any of example embodiments 19-22, wherein the conditional reconfiguration is one of: a conditional handover, CHO, a conditional PSCell change, CPC, a conditional PSCell addition, CPA, and a conditional PSCell change/addition, CPAC.

24. A user equipment, UE, configured to operate in a radio access network, the UE comprising:
radio interface circuitry configured to communicate with a network node via at least one cell; and
processing circuitry operably coupled to the radio interface circuitry, whereby the processing circuitry and the radio interface circuitry are configured to perform operations corresponding to any of the methods of claims 1-18.

25. A user equipment, UE, for operating in a radio access network, the UE being adapted to perform operations corresponding to any of the methods of claims 1-18.

26. A non-transitory, computer-readable medium storing computer-executable instructions that, when executed by processing circuitry of a user equipment, UE, configure the UE to perform operations corresponding to any of the methods of claims 1-18.

27. A computer program product comprising computer-executable instructions that, when executed by processing circuitry of a user equipment, UE, configure the UE to perform operations corresponding to any of the methods of claims 1-18.

28. A network node configured to serve one or more cells in a radio access network, the network node comprising:
radio interface circuitry configured to communicate with a user equipment, UE, via the at least one cell; and
processing circuitry operably coupled to the radio interface circuitry, whereby the processing circuitry and the radio interface circuitry are configured to perform operations corresponding to any of the methods of claims 19-23.

29. A network node adapted to serve at least one cell in a radio access network, the network node being further adapted to perform operations corresponding to any of the methods of claims 19-23.

30. A non-transitory, computer-readable medium storing computer-executable instructions that, when executed by processing circuitry of a network node, configure the network node to perform operations corresponding to any of the methods of claims 19-23.

31. A computer program product comprising computer-executable instructions that, when executed by processing circuitry of a network node in a radio access network, configure the network node to perform operations corresponding to any of the methods of claims 19-23.

32. A communication system including a host computer comprising:
processing circuitry configured to provide user data; and
a communication interface configured to forward the user data to a cellular network for transmission to a user equipment, UE,
wherein the cellular network comprises a base station having a radio interface and processing circuitry, the base station's processing circuitry configured to perform any of the steps of any of example embodiments 19-23.

33. The communication system of the previous embodiment further including the base station.

34. The communication system of the previous 2 embodiments, further including the UE, wherein the UE is configured to communicate with the base station.

35. The communication system of the previous 3 embodiments, wherein:
the processing circuitry of the host computer is configured to execute a host application, thereby providing the user data; and
the UE comprises processing circuitry configured to execute a client application associated with the host application.

36. A method implemented in a communication system including a host computer, a base station and a user equipment, UE, the method comprising:
at the host computer, providing user data; and
at the host computer, initiating a transmission carrying the user data to the UE via a cellular network comprising the base station, wherein the base station performs any of the steps of any of example embodiments 19-23.

37. The method of the previous embodiment, further comprising, at the base station, transmitting the user data.

38. The method of the previous 2 embodiments, wherein the user data is provided at the host computer by executing a host application, the method further comprising, at the UE, executing a client application associated with the host application.

39. A communication system including a host computer comprising:
processing circuitry configured to provide user data; and
a communication interface configured to forward user data to a cellular network for transmission to a user equipment, UE,
wherein the UE comprises a radio interface and processing circuitry, the UE's components 30 configured to perform any of the steps of any of example embodiments 1-18.

40. The communication system of the previous embodiment, wherein the cellular network further includes a base station configured to communicate with the UE.

41. The communication system of the previous 2 embodiments, wherein:
the processing circuitry of the host computer is configured to execute a host application, thereby providing the user data; and
the UE's processing circuitry is configured to execute a client application associated with the host application.

42. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of example embodiments 1-18.

43. The method of the previous embodiment, further comprising at the UE, receiving the user data from the base station.

44. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of example embodiments 1-18.

45. The communication system of the previous embodiment, further including the UE.

46. The communication system of the previous 2 embodiments, further including the base station, wherein the base station comprises a radio interface configured to communicate with the UE and a 30 communication interface configured to forward to the host computer the user data carried by a transmission from the UE to the base station.

47. The communication system of the previous 3 embodiments, wherein:
the processing circuitry of the host computer is configured to execute a host application; and
the UE's processing circuitry is configured to execute a client application associated with the host application, thereby providing the user data.

48. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

49. A method implemented in a communication system including a host computer, a base station and a user equipment (UE), the method comprising:
at the host computer, receiving user data transmitted to the base station from the UE, wherein the UE performs any of the steps of any of example embodiments 1-18.

50. The method of the previous embodiment, further comprising, at the UE, providing the user data to the base station.

51. The method of the previous 2 embodiments, further comprising:
at the UE, executing a client application, thereby providing the user data to be transmitted; and
at the host computer, executing a host application associated with the client application.

52. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

53. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of example embodiments 19-23.

54. The communication system of the previous embodiment further including the base station.

55. The communication system of the previous 2 embodiments, further including the UE, wherein the UE is configured to communicate with the base station.

56. The communication system of the previous 3 embodiments, wherein:
the processing circuitry of the host computer is configured to execute a host application;
the UE is configured to execute a client application associated with the host application, thereby providing the user data to be received by the host computer.

57. A method implemented in a communication system including a host computer, a base station and a user equipment (UE), the method comprising:
at the host computer, receiving, from the base station, user data originating from a transmission which the base station has received from the UE, wherein the UE performs any of the steps of any of example embodiments 1-18.

58. The method of the previous embodiment, further comprising at the base station, receiving the user data from the UE.

59. The method of the previous 2 embodiments, further comprising at the base station, initiating a transmission of the received user data to the host computer.

1-31. (canceled)

32. A method, in a user equipment (UE), the method comprising:
receiving a command instructing the UE to handover one or more radio bearers from a source cell to a target cell, wherein the command is received while the UE is evaluating execution conditions for a conditional reconfiguration;
detecting failure of the handover of at least one radio bearer from the source cell to the target cell; and,
in response to said detecting, performing evaluation of the execution conditions for the conditional reconfiguration.

33. The method of claim 32, wherein the method comprises:
stopping evaluation of the execution conditions for the one or more conditional reconfigurations in response to receiving the command; and
re-starting evaluation of the execution conditions for the conditional reconfiguration in response to detecting the failure of the handover.

34. The method of claim 32, wherein the command configures a dual-active protocol stack (DAPS) handover of at least one of the one or more radio bearers.

35. The method of claim 32, wherein the method comprises continuing evaluation of the execution for the conditional reconfiguration after receiving the command, in response to determining that the received command configures a dual-active protocol stack (DAPS) handover of at least one of the one or more radio bearers.

36. The method of claim 32, wherein the conditional reconfiguration is one of: a conditional handover (CHO), a conditional PSCell change (CPC), a conditional PSCell addition (CPA), and a conditional PSCell change/addition (CPAC).

37. The method of claim 32, wherein said performing evaluation of the execution conditions for the conditional reconfiguration is conditioned on the conditional configuration being of one or more particular types of conditional configuration.

38. The method of claim 37, wherein said performing evaluation of the execution conditions for the conditional reconfiguration is conditioned on the conditional configuration being a CHO or CPC but not a CPA.

39. The method of claim 32, wherein said performing evaluation of the execution conditions for the conditional reconfiguration is conditioned on the conditional reconfiguration not including the target cell for the handover.

40. A method, in a network node serving a user equipment, UE, the method comprising:
sending a command instructing the UE to handover one or more radio bearers from a source cell to a target cell; and
receiving, from the UE, an indication that evaluation by the UE of execution conditions for a conditional reconfiguration configured for the UE has stopped.

41. The method of claim 40, wherein the indication is included in a Failure Information message indicating failure of the handover.

42. The method of claim 40, further comprising:
sending, to the UE, subsequent to receiving the indication that evaluation of the execution conditions for the conditional reconfiguration has stopped, an indication to resume evaluation of the execution conditions for the conditional reconfiguration.

43. The method of claim 40, wherein the command configures a dual-active protocol stack (DAPS) handover of at least one of the one or more radio bearers.

44. The method of claim 40, wherein the conditional reconfiguration is one of: a conditional handover (CHO), a conditional PSCell change (CPC), a conditional PSCell addition (CPA), and a conditional PSCell change/addition (CPAC).

45. A user equipment (UE) configured to operate in a radio access network, the UE comprising:
radio interface circuitry configured to communicate with a network node via at least one cell; and
processing circuitry operably coupled to the radio interface circuitry, whereby the processing circuitry and the radio interface circuitry are configured to
receive a command instructing the UE to handover one or more radio bearers from a source cell to a target cell, wherein the command is received while the UE is evaluating execution conditions for a conditional reconfiguration;
detect failure of the handover of at least one radio bearer from the source cell to the target cell; and,
in response to said detecting, perform evaluation of the execution conditions for the conditional reconfiguration.

46. A network node configured to serve one or more cells in a radio access network, the network node comprising:
radio interface circuitry configured to communicate with a user equipment, UE, via the at least one cell; and
processing circuitry operably coupled to the radio interface circuitry, whereby the processing circuitry and the radio interface circuitry are configured to send a command instructing the UE to handover one or more radio bearers from a source cell to a target cell; and
receive, from the UE, an indication that evaluation by the UE of execution conditions for a conditional reconfiguration configured for the UE has stopped.
